(19) United States
(12) Patent Application Publication
(10) Pub. No.: US 2013/0149971 A1
(43) Pub. Date: Jun. 13, 2013

(54) COMMUNICATION APPARATUS, COMMUNICATION METHOD, AND COMPUTER PRODUCT

(71) Applicant: FUJITSU MOBILE COMMUNICATIONS LIMITED, Kawasaki-shi (JP)

(72) Inventor: Kazuyo MOMONO, Kokubunji (JP)

(73) Assignee: FUJITSU MOBILE COMMUNICATIONS LIMITED, Kawasaki-shi (JP)

(21) Appl. No.: 13/664,319

(22) Filed: Oct. 30, 2012

(30) Foreign Application Priority Data
Dec. 12, 2011 (JP) 2011-271784

(51) Int. Cl. H04W 24/00

(52) U.S. Cl. 455/67.11

(57) ABSTRACT

Communication apparatuses T1 to T3 are mutually located in the communication areas of one another and by exchanging data, respectively have the same data D1 to D3. Each of the communication apparatuses T executes connection processing of connecting to a network N via a base station BS. When any one among the communication apparatuses T1 to T3, such as T2, is able to connect to the network N, the communication apparatus (T2) transmits the data D1 to D3 to respective destination and transmits to the other communication apparatuses (T1, T3), information that indicates that the data D1 to D3 have been transmitted. The other communication apparatuses (T1, T3), upon receiving the information, realized that the data D1 to D3 have been transmitted and thus, suspend connection processing to connect to the network N.

### CROSS REFERENCE TO RELATED APPLICATIONS

This application is based upon and claims the benefit of priority of the prior Japanese Patent Application No. 2011-271784, filed on Dec. 12, 2011, the entire contents of which are incorporated herein by reference.

### FIELD

The embodiment discussed herein is related to a communication apparatus, a communication method, and a communication program.

### BACKGROUND

A conventional communication apparatus transmits to a base station, a connection request to a network and after being connected to the network, starts communication via the base station. A related technology has been suggested that coordinates mobile phones by short-distance communication when a disaster occurs, and allows any of the mobile phones to notify an emergency via the base station (see, for example, Japanese Laid-Open Patent Publication No. 2009-124448). A technology has also been suggested that notifies an emergency via the base station automatically upon detection of an occurrence of a disaster (see, for example, Japanese Laid-Open Patent Publication No. 2007-88948).

A technology has also been suggested in which a terminal that cannot communicate with the base station directly communicates with the base station via a terminal that can communicate with the base station (see, for example, Japanese Laid-Open Patent Publication No. 2010-287934). A technology has also been suggested that sets any one of terminals as a leader terminal that controls communication among the terminals (see, for example, Japanese Laid-Open Patent Publication No. 2007-336360). A technology has also been suggested in which relay stations and mobile stations in a wireless communication network use the same frequency, and an ID for identifying a source station is included in a message (see, for example, Japanese Laid-Open Patent Publication No. 2007-158769).

In the conventional technologies described above, however, connection requests concentrate on the base station and the network becomes congested if a number of emergency notifications are transmitted from the mobile terminals when a disaster occurs, or if a number of e-mails are transmitted from the mobile terminals at an event such as New Year.

### SUMMARY

According to an aspect of an embodiment, a communication apparatus includes a first communication unit that communicates with one or more other communication apparatus(es) located in a communication area of the communication apparatus; a second communication unit that communicates with any of base stations in a mobile communication network; and a processor configured to: cause the first communication unit to receive from the other communication apparatus(es), information indicating whether identical data stored in the communication apparatus and the other communication apparatus(es) have been transmitted to a destination in the mobile communication network; determine whether the data have been transmitted based on the information received by the first communication unit and information stored in the communication apparatus and indicating whether the data have been transmitted; cause, upon determining that the data have not yet been transmitted, the second communication unit to execute a connection process to the mobile communication network via the base station and to transmit the data to the destination via the base station; update, if the second communication unit successfully transmits the data, the information stored in the communication apparatus so as to indicate that the data have been transmitted; cause, upon updating the information, the first communication unit to distribute the updated information to the other communication apparatus(es); and cause, upon determining that the data have been transmitted, the second communication unit to suspend the ongoing connection process.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIGS. 1A and 1B are diagrams of contents of a transmission suspension process performed by a communication apparatus according to an embodiment;

FIG. 2 is a hardware block diagram of the communication apparatus T according to the embodiment;

FIG. 3 is a diagram of an example of contents of a sensor information table;

FIG. 4 is a diagram of an example of contents of a state information table;

FIG. 5 is a diagram of an example of contents of a summary information table;

FIG. 6 is a functional block diagram of the communication apparatus T;

FIGS. 7A and 7B are diagrams of a specific example of a congestion suppression process (part 1);

FIGS. 8A and 8B are diagrams of the specific example of the congestion suppression process (part 2);

FIGS. 9A and 9B are diagrams of the specific example of the congestion suppression process (part 3);

FIGS. 10A and 10B are diagrams of the specific example of the congestion suppression process (part 4);

FIGS. 11A and 11B are diagrams of the specific example of the congestion suppression process (part 5);

FIGS. 12A and 12B are diagrams of the specific example of the congestion suppression process (part 6);

FIG. 13 is a diagram of the specific example of the congestion suppression process (part 7);

FIG. 14A is a flowchart of a first example of the congestion suppression process (part 1);

FIG. 14B is a flowchart of the first example of the congestion suppression process (part 2);

FIG. 15A is a flowchart of a second example of the congestion suppression process (part 1);

FIG. 15B is a flowchart of the second example of the congestion suppression process (part 2);

FIG. 16 is a flowchart of a state determination process;

FIG. 17 is a flowchart of an information distribution process;

FIG. 18 is a diagram of an example of contents of the sensor information table of the communication apparatus T applied to an automatic disaster warning apparatus;

FIG. 19 is a diagram of an example of contents of the state information table of the communication apparatus T applied to the automatic disaster warning apparatus;

FIG. 20 is a diagram of an example of contents of the summary information table of the communication apparatus T applied to the automatic disaster warning apparatus;

FIG. 21A is a flowchart of a first example of the congestion suppression process performed by the communication apparatus T applied to the automatic disaster warning apparatus (part 1);

FIG. 21B is a flowchart of the first example of the congestion suppression process performed by the communication apparatus T applied to the automatic disaster warning apparatus (part 2);

FIG. 22A is a flowchart of a first example of the congestion suppression process performed by the communication apparatus T applied to the automatic disaster warning apparatus (part 1); and

FIG. 22B is a flowchart of a second example of the congestion suppression process performed by the communication apparatus T applied to the automatic disaster warning apparatus (part 2).

### DESCRIPTION OF EMBODIMENTS

An embodiment of a communication apparatus, a communication method, and a communication program according to the present invention is described in detail below with reference to the accompanying drawings.

A transmission suspension process performed by a communication apparatus according to the embodiment is described first.

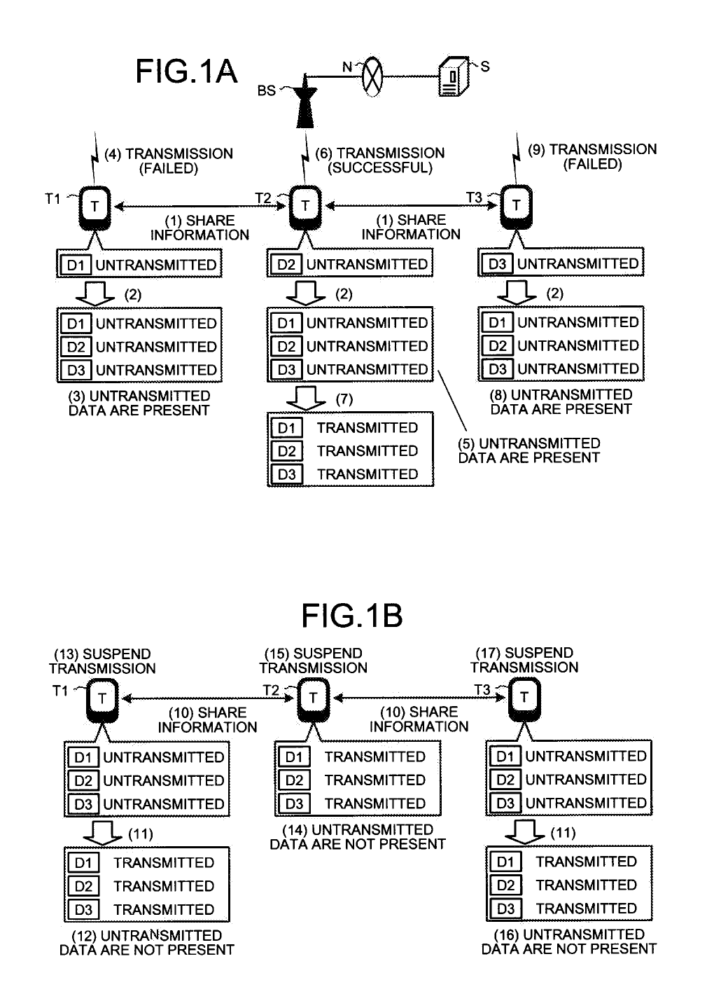

FIG. 1 is a diagram of the transmission suspension process performed by the communication apparatus according to the embodiment. A communication apparatus T depicted in FIG. 1 includes an inter-device wireless transceiver that is wirelessly connected to other communication apparatuses T located in the communication area of the communication apparatus T and exchanges data directly with the other communication apparatuses T. Communication apparatuses T1 to T3 are communication apparatuses T mutually located in the communication areas of one another.

The communication apparatus T also includes an inter-carrier wireless transceiver that is connected to a network N via a base station BS and exchanges data with an apparatus S in the network N that is a mobile communication network using the 3rd Generation (3G) communication scheme such as Wideband-Code Division Multiple Access (W-CDMA), CDMA 2000, and Worldwide Interoperability for Microwave Access (WiMAX), or using a succeeding next-generation communication scheme. W-CDMA, CDMA 2000, and WiMAX are registered trademarks.

The communication apparatus T1 includes data D1 addressed to the apparatus S in the network N, and information indicating the data D1 have not yet been transmitted. The communication apparatus T2 includes data D2 addressed to the apparatus S in the network N, and information indicating the data D2 have not yet been transmitted. The communication apparatus T3 includes data D3 addressed to the apparatus S in the network N, and information indicating the data D3 have not yet been transmitted.

The communication apparatuses T1 to T3 exchange, by the inter-device wireless transceiver, the data and the information indicating whether the data have been transmitted, whereby each of the communication apparatuses T1 to T3 has the data D1 to D3 and information indicating whether the data D1 to D3 have been transmitted. Each of the communication apparatuses T1 to T3 executes a connection process to the network N by the inter-carrier wireless transceiver, and transmits the data D1 to D3 to the destination after being connected to the network N. In the connection process to the network N, the communication apparatuses T1 to T3 transmit to the base station BS, a connection request to the network N one or more times until being connected to the network N.

Thus, the communication apparatus T executes the connection process to the network N and tries to transmit the data to the destination in cooperation with the other communication apparatuses T in the communication area, thereby improving the success rate of data transmission. For example, the communication apparatus T2 can transmit the data D1 to D3 to the destination provided the communication apparatus T2 can connect to the base station BS, even when no base station BS is present near the communication apparatus T1 or the base station BS near the communication apparatus T3 is in failure.

If any one of the communication apparatuses T1 to T3 has successfully transmitted the data D1 to D3 to the destination, the communication apparatus T transmits to the other communication apparatuses T, information indicating the data D1 to D3 have been transmitted. The communication apparatuses T1 to T3 determines the data D1 to D3 have been transmitted if the apparatus has successfully transmitted the data D1 to D3 or the apparatus has received information indicating the data D1 to D3 have been transmitted. The communication apparatuses T1 to T3 suspend the connection process to the network N performed by the inter-carrier wireless transceiver. Thus, the communication apparatus T suspends the transmission of the connection request to the base station BS, thereby reducing the processing load of the base station BS and suppressing the congestion of the network N.

For example, as depicted in FIG. 1A, (1) the communication apparatus T1 pairs with and connects to the communication apparatus T2 in the communication area by the inter-device wireless transceiver. The pairing is a process for the communication apparatuses T located in the other's communication area to authenticate with each other before being connected. The communication apparatus T1 transmits to the communication apparatus T2 by the inter-device wireless transceiver, the data D1 and the information indicating the data D1 have not yet been transmitted.

The communication apparatus T2 receives from the communication apparatus T1 by the inter-device wireless transceiver, the data D1 and the information indicating the data D1 have not yet been transmitted and transmits to the communication apparatus T1, the data D2 and the information indicating the data D2 have not yet been transmitted. The communication apparatus T1 receives the data D2 and the information indicating the data D2 have not yet been transmitted that are stored in the communication apparatus T2, from the communication apparatus T2 by the inter-device wireless transceiver.

Since another communication apparatus T3 is present in the communication area with which the communication apparatus T1 has not yet paired, the communication apparatus T1 pairs with and connects to the communication apparatus T3 by the inter-device wireless transceiver in a similar manner. The communication apparatus T1 transmits to the communication apparatus T3 by the inter-device wireless transceiver, the data D1, the information indicating the data D1 have not yet been transmitted, and the data D2 and the information indicating the data D2 have not yet been transmitted that are received from the communication apparatus T2.

The communication apparatus T3 receives from the communication apparatus T1 by the inter-device wireless transceiver, the data D1 and D2 and the information indicating the data D1 and D2 have not yet been transmitted and transmits to the communication apparatus T1, the data D3 and the information indicating the data D3 have not yet been transmitted. The communication apparatus T1 receives from the communication apparatus T3 by the inter-device wireless transceiver, the data D3 and the information indicating the data D3 have not yet been transmitted. The communication apparatus T1 may not transmit the data D2 received from the communication apparatus T2 to the communication apparatus T3.

In a similar manner to the communication apparatus T1, the communication apparatus T2 pairs with and connects to the communication apparatus T3 with which the communication apparatus T2 has not yet paired, by the inter-device wireless transceiver. The communication apparatus T2 transmits to the communication apparatus T3 by the inter-device wireless transceiver, the data D2 and the information indicating the data D2 have not yet been transmitted.

The communication apparatus T3 receives from the communication apparatus T2 by the inter-device wireless transceiver, the data D1 and D2 and the information indicating the data D1 and D2 have not yet been transmitted and transmits to the communication apparatus T2, the data D1 to D3 and the information indicating the data D1 to D3 have not yet been transmitted. The communication apparatus T2 receives from the communication apparatus T3 by the inter-device wireless transceiver, the data D1 to D3 and the information indicating the data D1 to D3 have not yet been transmitted.

In a similar manner to the communication apparatus T1, the communication apparatus T3 pairs with a communication apparatus T in the communication area with which the communication apparatus T3 has not yet paired, by the inter-device wireless transceiver. In the example of FIG. 1, the communication apparatus T3 pairs with no communication apparatus T since no more communication apparatus T is present in the communication area with which the communication apparatus T3 has not yet paired. Thus, the communication apparatuses T1 to T3 exchange the data and the information indicating the data have not yet been transmitted that are stored in the communication apparatuses T1 to T3, respectively.

(2) As a result, each of the communication apparatuses T1 to T3 stores therein the data D1 to D3 and the information indicating the data D1 to D3 have not yet been transmitted.

(3) The communication apparatus T1 determines whether untransmitted data are present among the data D1 to D3 stored in the communication apparatus T1. In the example of FIG. 1, the communication apparatus T1 determines untransmitted data D1 to D3 are present based on the information indicating the data D1 to D3 have not yet been transmitted. (4) In this case, the communication apparatus T1 transmits a connection request to the base station BS by the inter-carrier wireless transceiver. However, it is assumed that communication apparatus T1 fails to connect to the network N and thus fails to transmit the untransmitted data D1 to D3 to the destination.

(5) The communication apparatus T2 determines whether untransmitted data are present among the data D1 to D3 stored in the communication apparatus T2. In the example of FIG. 1, the communication apparatus T2 determines untransmitted data D1 to D3 are present based on the information indicating the data D1 to D3 have not yet been transmitted. (6) In this case, the communication apparatus T2 transmits a connection request to the base station BS by the inter-carrier wireless transceiver. It is assumed that the communication apparatus T2 has successfully connected to the network N via the base station BS and thus successfully transmitted the data D1 to D3 to the destination.

(7) Since the communication apparatus T2 has successfully transmitted the data D1 to D3 to the destination, the communication apparatus T2 updates the information stored in the communication apparatus T2 and indicating the data D1 to D3 have not yet been transmitted so as to indicate the data have been transmitted.

(8) The communication apparatus T3 determines whether untransmitted data are present among the data D1 to D3 stored in the communication apparatus T3. In the example of FIG. 1, the communication apparatus T3 determines untransmitted data D1 to D3 are present based on the information indicating the data D1 to D3 have not yet been transmitted. (9) In this case, the communication apparatus T3 transmits a connection request to the base station BS by the inter-carrier wireless transceiver. However, it is assumed that communication apparatus T3 fails to connect to the network N and thus fails to transmit the untransmitted data D1 to D3 to the destination.

Thus, if the communication apparatus T2 can connect to the network N, the communication apparatus T2 transmits the data D1 to D3 to the destination on behalf of the communication apparatuses T1 and T3 even when the communication apparatuses T1 and T3 cannot connect to the network N due to, for example, a congestion of the network N caused by a concentration of connection requests on the base station BS near the communication apparatus T, an absence of the base station BS near the communication apparatus T, or a failure in the base station BS near the base station BS.

As a result, the communication apparatuses T1 and T3 need not to transmit the data D1 to D3 to the destination and can suspend the connection process to the network N, since the communication apparatus T2 has already transmitted the data D1 to D3 to the destination on behalf of the communication apparatuses T1 and T3.

As described in FIG. 1B, (10) the communication apparatuses T1 to T3 pair with and connect to each other by the inter-device wireless transceiver in a similar manner to (1) of FIG. 1A, and exchange the data D1 to D3 and the information indicating whether the data D1 to D3 have been transmitted that are stored in the communication apparatuses T1 to T3, respectively. The communication apparatuses T1 and T3 receive from the communication apparatus T2 by the inter-device wireless transceiver, the information indicating the data D1 to D3 have been transmitted, and update the information stored therein and indicating the data D1 to D3 have not yet been transmitted so as to indicate the data D1 to D3 have been transmitted.

(11) As a result, each of the communication apparatuses T1 to T3 stores therein the data D1 to D3 and the information indicating the data D1 to D3 have been transmitted.

(12) The communication apparatus T1 determines whether untransmitted data are present among the data D1 to D3 stored in the communication apparatus T1. In the example of FIG. 1, the communication apparatus T1 determines no untransmitted data are present based on the information indicating the data D1 to D3 have been transmitted. (13) In this case, the communication apparatus T1 suspends the connection process to the network N performed by the inter-carrier wireless transceiver.

Similarly, since no more untransmitted data are present among the data D1 to D3 stored in the communication apparatus T2, (15) the communication apparatus T2 suspends the connection process to the network N performed by the inter-carrier wireless transceiver. (16) Similarly, since no more untransmitted data are present among the data D1 to D3 stored in the communication apparatus T3, (17) the communication apparatus T3 suspends the connection process to the network N performed by the inter-carrier wireless transceiver.

Thus, if any of the communication apparatuses T has successfully transmitted the data D1 to D3 to the destination, the communication apparatus T transmits to the other communication apparatuses T, information indicating the data D1 to D3 have been transmitted. The other communication apparatuses T determine the data D1 to D3 stored therein have been transmitted, and suspend the connection process to the network N performed by the inter-carrier wireless transceiver. Thus, transmission of connection request from the communication apparatuses T to the base station BS is suspended, thereby reducing the processing load of the base station BS and suppressing the congestion of the network N.

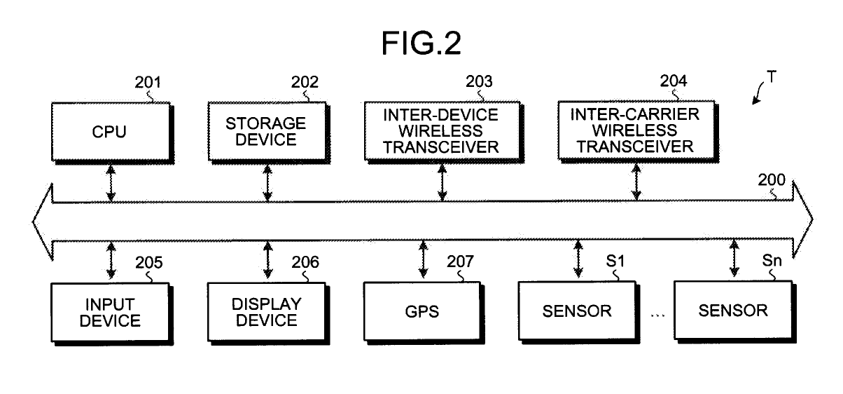

FIG. 2 is a hardware block diagram of the communication apparatus T according to the embodiment. As depicted in FIG. 2, the communication apparatus T includes a central processing unit (CPU) 201, a storage device 202, an inter-device wireless transceiver 203, an inter-carrier wireless transceiver 204, an input device 205, a display device 206, a global positioning system (GPS) 207, and sensors S1 to Sn that are connected to each other via a bus 200.

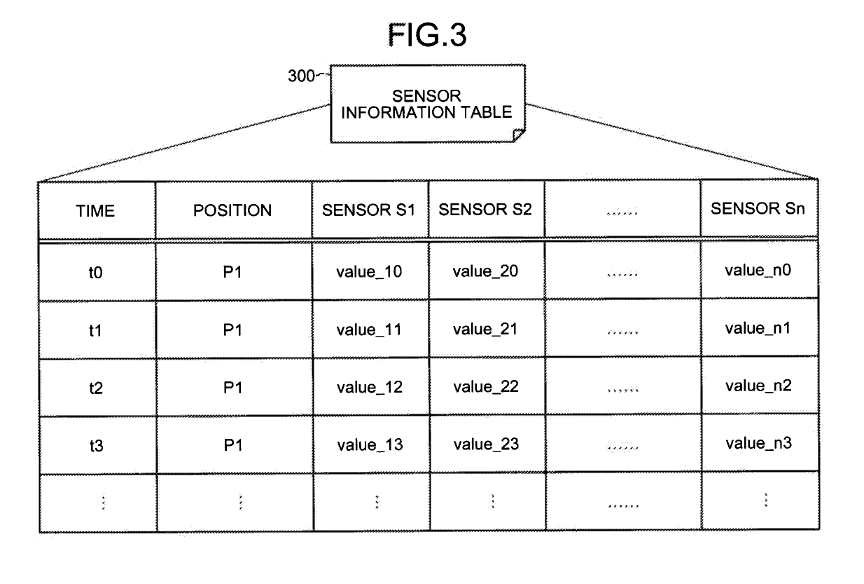

The CPU 201 governs the overall control of the communication apparatus T. The storage device 202 stores therein a program such as a boot program, and is used as a work area of the CPU 201. The storage device 202 stores therein a sensor information table, a state information table, and a summary information table that are described later with reference to FIGS. 3 to 5, respectively.

The inter-carrier wireless transceiver 204 connects to the network N via the base station BS, and exchanges data with the apparatus S in the network N that is a mobile communication network using the 3G communication scheme such as W-CDMA, CDMA 2000, and WiMAX, or using a succeeding next-generation communication scheme. For example, a local area network (LAN) adapter including a 3G antenna used for the 3G communication can be employed as the inter-carrier wireless transceiver 204.

The inter-device wireless transceiver 203 is wirelessly connected to the other communication apparatuses T located in the communication area of the communication apparatus T, and exchanges data directly with the other communication apparatuses T. For example, a LAN adapter including an antenna used for a Bluetooth communication or a wireless fidelity (WiFi) communication, or an IC card including an antenna used for a contactless FeliCa communication can be employed as the inter-device wireless transceiver 203. Bluetooth, WiFi, and FeliCa are registered trademarks.

The input device 205 inputs data. The input device 205 includes keys for inputting characters, numerals, and various instructions, and is implemented by a keyboard for data input, a touch-panel input pad, or a numerical keypad. The input device 205 may be a camera that reads images optically and takes image data into the communication apparatus T.

The display device 206 is a display that displays a cursor, icons, tool boxes, and data such as a text, an image, and functional information. For example, a CRT, a TFT liquid-crystal display, or a plasma display can be employed as the display. The display device 206 may be a printer that prints image data, text data, etc. For example, a laser printer or an inkjet printer can be employed as the printer.

The GPS 207 obtains position information of the communication apparatus T. The position information is, for example, GPS coordinates that include the latitude and the altitude of the position of the communication apparatus T calculated based on a radio wave received from the GPS satellite. The sensors S1 to Sn obtain data concerning the state of the communication apparatus T. For example, a velocity sensor, an illumination sensor, and/or a temperature sensor can be employed as the sensors S1 to Sn.

Contents of the sensor information table are described next with reference to FIG. 3. The sensor information table is included in the communication apparatus T, stores sensor information that is a set of information concerning the communication apparatus T obtained by the GPS 207 and the sensors S1 to Sn at a given time, and is referred to for identifying the state of the communication apparatus T.

For example, the communication apparatus T has a state indicating the communication apparatus T is located at a place on which connection requests to the base station BS concentrate. The communication apparatus T may have a state indicating the communication apparatus T is located indoors or outdoors. The communication apparatus T may have a state indicating a specific location of the communication apparatus T. The communication apparatus T may have a state indicating the type of a disaster if the communication apparatus T is applied to an automatic disaster warning apparatus. The sensor information table is implemented by the storage device 202.

FIG. 3 is a diagram of an example of contents of the sensor information table. As depicted in FIG. 3, the sensor information table 300 includes a position field and one or more sensor fields that are associated with a time field, and stores a record for each time when information obtained by the sensors S1 to Sn are collected to generate the sensor information.

The time field stores the time when information obtained by the sensors S1 to Sn are collected to generate the sensor information. The position field stores the position information obtained by the GPS 207 at the time indicated by the time field.

The sensor fields store the values obtained by the sensors S1 to Sn, respectively. The sensor fields correspond to the sensors S1 to Sn, respectively; and n fields are present in the example of FIG. 3 (i.e., the sensor S1 field to the sensor Sn field).

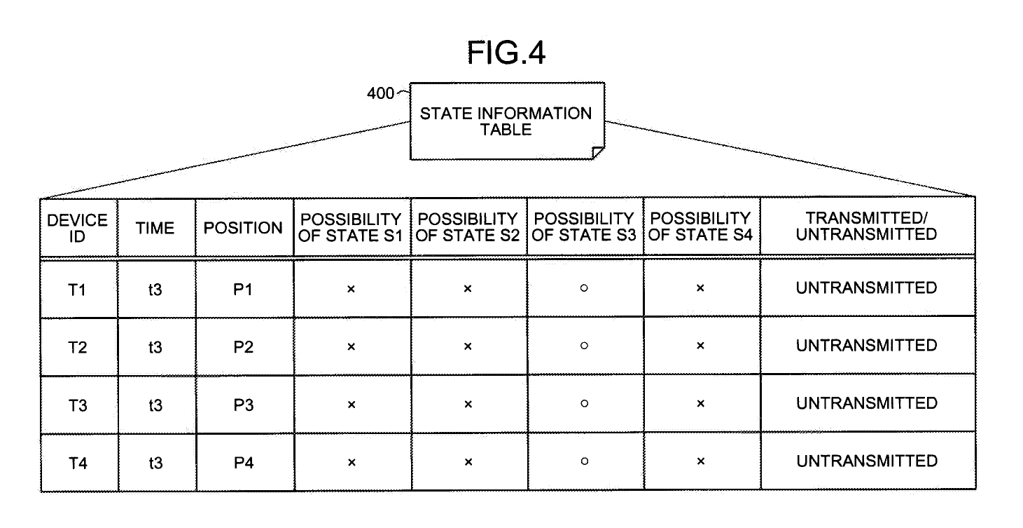

Contents of the state information table are described next with reference to FIG. 4. The state information table is included in the communication apparatus T, and stores state information and whether the state information has been transmitted to the destination. The state information is data to be transmitted to the destination in the network N and is, for example, information indicating the state of the communication apparatus T identified based on the sensor information.

For example, the communication apparatus T identifies the state of the communication apparatus T as being in a shrine if the current date is December 31 and the position information obtained by the GPS 207 indicates a position near the shrine. The communication apparatus T identifies the state of the communication apparatus T as being in a stadium if the position information obtained by the GPS 207 indicates a position near the stadium and the illumination obtained by the illumination sensor is within a general range of illumination of a stadium (for example, 750 to 1500(1×)).

Thus, the communication apparatus T identifies a state in which the communication apparatus T is located at a place such as a shrine and a stadium on which connection requests to the base station BS are likely to concentrate. Information on the location of the shrine and the stadium may be preliminarily stored in the communication apparatus T, or may be received from a communication service provider via the base station BS. The state information stored in the state information table may be employed as the data D1 to D3 depicted in FIG. 1. The state information table is implemented by the storage device 202.

FIG. 4 is a diagram of an example of contents of the state information table. As depicted in FIG. 4, the state information table 400 includes a position field, one or more possibility-of-state fields, and a transmitted/untransmitted field that are associated with a time field, and stores a record for each time when the state of the communication apparatus T is identified based on the sensor information.

The time field stores the time when the state of the communication apparatus T is identified based on the sensor information. The position field stores GPS coordinates indicating the position of the communication apparatus T at the time indicated by the time field. The possibility-of-state field stores the possibility for the communication apparatus T to be in the state deduced as a result of the identification of the state of the communication apparatus T based on the sensor information. 4 possibility-of-state fields are present in the example of FIG. 4 (i.e., the possibility of state S1 field to the possibility of state S4 field).

The transmitted/untransmitted field stores whether the state information has been transmitted. The state information is, for example, the contents of the time field, the position field, and one or more possibility-of-state fields.

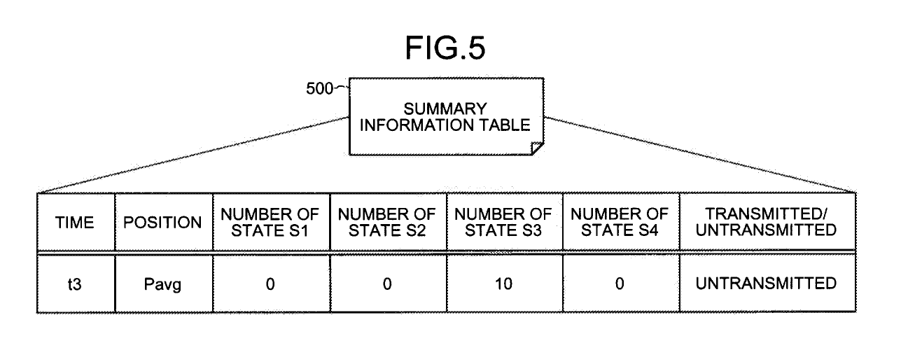

Contents of the summary information table are described next with reference to FIG. 5. The summary information table is included in the communication apparatus T, and stores summary information and whether the summary information has been transmitted to the destination. The summary information is data to be transmitted to the destination in the network N, and indicates the number of communication apparatuses T in each state generated from the state information of each communication apparatus T. The summary information table is implemented by the storage device 202.

FIG. 5 is a diagram of an example of contents of the summary information table. As depicted in FIG. 5, the summary information table 500 includes a position field, one or more number-of-state fields, and a transmitted/untransmitted field that are associated with a time field, and stores a record for each time when the summary information is generated based on the state information.

The time field stores the time when the summary information is generated based on the state information. The position field stores GPS coordinates indicating the position of the communication apparatuses T at the time indicated by the time field. For example, the average of GPS coordinates indicating the position of each communication apparatus T is employed as the position of the communication apparatuses T.

The number-of-state field stores the number of communication apparatuses T in the state obtained as a result of summarizing the state information. 4 number-of-state fields are present in the example of FIG. 5 (i.e., the number of state S1 field to the number of state S4 field).

The transmitted/untransmitted field stores whether the summary information has been transmitted. The summary information is, for example, the contents of the time field, the position field, and one or more number-of-state fields.

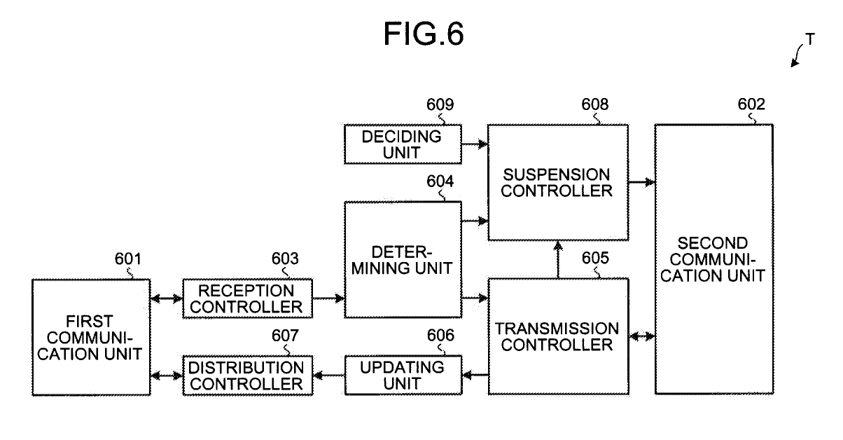

An example of a functional configuration of the communication apparatus T is described next with reference to FIG. 6.

FIG. 6 is a functional block diagram of the communication apparatus T that includes a first communication unit 601, a second communication unit 602, a reception controller 603, a determining unit 604, a transmission controller 605, an updating unit 606, a distribution controller 607, a suspension controller 608, and a deciding unit 609. Functions of the reception controller 603 to the deciding unit 609 are implemented by, for example, the CPU 201 executing a program stored in the storage device 202 depicted in FIG. 2.

The first communication unit 601 communicates with other the communication apparatuses T located in the communication area of the communication apparatus T. For example, the first communication unit 601 is the inter-device wireless transceiver 203 described above, and is wirelessly connected to the other communication apparatuses T located in the communication area of the communication apparatus T and exchanges data directly with the other communication apparatuses T. For example, a LAN adapter including an antenna used for a Bluetooth communication or a wireless fidelity (WiFi) communication, or an IC card including an antenna used for a contactless FeliCa communication can be employed as the first communication unit 601.

The second communication unit 602 communicates with any of the base stations BS in the mobile communication network that is, for example, the network N using the 3G communication scheme such as W-CDMA, CDMA 2000, and WiMAX, or using a succeeding next-generation communication scheme. For example, the second communication unit 602 is the inter-carrier wireless transceiver 204 described above, and connects to the network N via the base station BS and exchanges data with the apparatus S in the network N. For example, a LAN adapter including a 3G antenna used for the 3G communication can be employed as the second communication unit 602.

The reception controller 603 causes the first communication unit 601 to receive from one or more other communication apparatuses T, information indicating whether identical data stored in the communication apparatus T and the other communication apparatuses T have been transmitted to the destination in the mobile communication network. The identical data are addressed to the apparatus S in the network N. For example, the state information stored in the state information table 400 is employed as the identical data.

The summary information stored in the summary information table 500 may be employed as the identical data. Data input by a user of the communication apparatus T through the input device 205 may be employed as the identical data. Any of the communication apparatus T and the other communication apparatuses T transmits data to the remaining communication apparatuses T, whereby the communication apparatus T and the other communication apparatuses T have the identical data. Here, it is assumed that the inter-device wireless transceiver 203 pairs with one communication apparatus T at one time.

The reception controller 603 causes the inter-device wireless transceiver 203 to pair with another communication apparatus T in the communication area and to connect the communication apparatus T to the other communication apparatus T. The pairing is a process for communication apparatuses T located in the other's communication area to authenticate with each other before being connected. The reception controller 603 causes the inter-device wireless transceiver 203 to receive from the other communication apparatus T, information indicating whether data have been transmitted. The reception controller 603 obtains information indicating whether the data received by the inter-device wireless transceiver 203 have been transmitted.

The reception controller 603 causes the inter-device wireless transceiver 203 to release the pairing. The reception controller 603 causes the inter-device wireless transceiver 203 to execute the series of processes described above (i.e., the pairing, the reception of the information, and the release of the pairing) if any other communication apparatus T is present in the communication area with which the communication apparatus T has not yet paired.

Thus, the reception controller 603 receives information from one or more communication apparatuses T in the communication area by causing the inter-device wireless transceiver 203 to execute the series of processes described above for each communication apparatus T in the communication area. Here, it is assumed that the inter-device wireless transceiver 203 pairs with one communication apparatus T at one time. Alternatively, the inter-device wireless transceiver 203 may have a multi-pairing function for pairing with multiple communication apparatuses T. In this case, the pairing need not to be released. Thus, the reception controller 603 receives information used for determination by the determining unit 604. The received information is stored in the storage device 202.

The determining unit 604 determines whether data have been transmitted based on the information received by the first communication unit 601 and the information stored in the communication apparatus T and indicating whether data have been transmitted. For example, the determining unit 604 determines data have been transmitted if the information obtained by the reception controller 603 indicates the data have been transmitted. The determining unit 604 also determines data have been transmitted if the information stored in the communication apparatus T indicates the data have been transmitted. Thus, the determining unit 604 determines whether the data have been transmitted and whether to transmit the data to the destination by its own. The result of the determination is stored in the storage device 202.

The transmission controller 605 causes the second communication unit 602 to execute the connection process to the mobile communication network via the base station BS when the determining unit 604 determines the data have not yet been transmitted, and to transmit the data to the destination via the base station BS after being connected to the mobile communication network. The connection process is a process of attempting to connect to the network by transmitting a connection request to the base station BS one or more times. The transmission controller 605 causes the inter-carrier wireless transceiver 204 to transmit to the base station BS, the connection request to the network N if the determining unit 604 determines the data have not yet been transmitted, and to transmit the data to the destination via the base station BS if the inter-carrier wireless transceiver 204 receives a response indicating a successful connection from the base station BS.

The inter-carrier wireless transceiver 204 determines the connection has failed if no response is received from the base station BS for a given period of time. In this case, the inter-carrier wireless transceiver 204 may retransmit the connection request to the base station BS. Thus, the transmission controller 605 transmits the data to the destination via the base station BS as a representative of the communication apparatuses T in the communication area if the transmission controller 605 has successfully connected to the network N.

The updating unit 606 updates information stored in the communication apparatus T so as to indicate the data have been transmitted if the second communication unit 602 has successfully transmitted the data (for example, if a response is received from the destination via the base station BS by the inter-carrier wireless transceiver 204). Thus, thereafter the updating unit 606 causes the determining unit 604 to determine the data have been transmitted.

The updating unit 606 also updates the information stored in the communication apparatus T so as to indicate the data have been transmitted if the determining unit 604 determines the data have been transmitted. In other words, if the information indicates the data have not yet been transmitted but the determining unit 604 determines the data have been transmitted, the updating unit 606 updates the information so as to indicate the data have been transmitted. Thus, thereafter the updating unit 606 causes the determining unit 604 to determine the data have been transmitted.

The distribution controller 607 causes the first communication unit 601 to distribute, when the updating unit 606 updates the information, the updated information to one or more communication apparatuses T. Here, it is assumed that the inter-device wireless transceiver 203 pairs with one communication apparatus T at one time. The distribution controller 607 causes the inter-device wireless transceiver 203 to pair with another communication apparatus T in the communication area and to connect the communication apparatus T to the other communication apparatus T. The distribution controller 607 causes the inter-device wireless transceiver 203 to transmit the updated information to the other communication apparatus T.

The distribution controller 607 causes the inter-device wireless transceiver 203 to release the pairing upon completion of the transmission. The distribution controller 607 causes the inter-device wireless transceiver 203 to execute the series of processes described above (i.e., the pairing, the reception of the information, and the release of the pairing) if any other communication apparatus T is present in the communication area with which the communication apparatus T has not yet paired.

Thus, the distribution controller 607 distributes information stored in the communication apparatus T to one or more communication apparatuses T in the communication area by causing the inter-device wireless transceiver 203 to execute the series of processes described above for each communication apparatus T in the communication area. Here, it is assumed that the inter-device wireless transceiver 203 pairs with one communication apparatus T at one time. Alternatively, the inter-device wireless transceiver 203 may have a multi-pairing function for pairing with multiple communication apparatuses T. In this case, the pairing need not to be released. Thus, the transmission controller 605 notifies the other communication apparatuses T in the communication area that the data have been successfully transmitted from the communication apparatus T, and causes the other communication apparatuses T to determine whether to suspend the connection process to the network N.

The suspension controller 608 causes the second communication unit 602 to suspend the ongoing connection process (for example, causes the inter-carrier wireless transceiver 204 to suspend the transmission of the connection request to the network N) if the determining unit 604 determines the data have been transmitted. Thus, the suspension controller 608 suspends the transmission of the connection request to the base station BS, thereby reducing the processing load of the base station BS, suppressing the congestion of the network N, and suppressing the battery consumption of the communication apparatus T.

The suspension controller 608 may cause the second communication unit 602 to suspend the ongoing connection process if the connection process fails. For example, the suspension controller 608 causes the inter-carrier wireless transceiver 204 to suspend the transmission of the connection request to the network N if no response indicating a successful connection is received from the base station BS by the inter-carrier wireless transceiver 204 within a given period of time from the transmission of the connection request. Thus, the suspension controller 608 suspends the transmission of the connection request to the base station BS, thereby reducing the processing load of the base station BS, suppressing the congestion of the network N, and suppressing the battery consumption of the communication apparatus T.

The determining unit 604 may determine whether the communication apparatus T satisfies a connection requirement to the mobile communication network, that is, for example: whether the remaining battery amount of the communication apparatus T is equal to or more than a threshold; the receiving sensitivity of a radio wave of the inter-carrier wireless transceiver 204 of the communication apparatus T is equal to or higher than a threshold; or the priority of communication set for the communication apparatus T among the communication apparatuses T in the communication area is equal to or higher than a threshold. Thus, the determining unit 604 does not cause the transmission controller 605 to execute the process if the communication apparatus T does not satisfy the connection requirement, thereby suppressing the battery consumption of the communication apparatus T and the congestion of the network N. The result of the determination is stored in the storage device 202.

In this case, if the determining unit 604 determines the data have not yet been transmitted and the connection requirement is satisfied, the transmission controller 605 causes the second communication unit 602 to execute the connection process to the mobile communication network via the base station BS and to transmit the data to the destination via the base station BS. For example, the transmission controller 605 causes the inter-carrier wireless transceiver 204 to transmit to the base station BS, the connection request to the network N and to transmit the data via the base station BS if a response indicating a successful connection is received from the base station BS by the inter-carrier wireless transceiver 204. Thus, the transmission controller 605 transmits the data to the destination via the base station BS as a representative of the communication apparatuses T in the communication area if the transmission controller 605 has successfully connected to the network N.

The deciding unit 609 decides whether to suspend transmission of data from the communication apparatus T. For example, the deciding unit 609 decides to suspend the transmission when a cancellation of a disaster warning is received by the inter-carrier wireless transceiver 204, or when an instruction to suspend transmission is input from a user. Thus, the deciding unit 609 provides the suspension controller 608 with a trigger to suspend the transmission of data performed by the inter-carrier wireless transceiver 204. The result of the decision is stored in the storage device 202.

The suspension controller 608 causes the second communication unit 602 to suspend the ongoing connection process if the deciding unit 609 decides to suspend the transmission. For example, the suspension controller 608 causes the inter-carrier wireless transceiver 204 to suspend the transmission of the connection request to the network N. Thus, the suspension controller 608 suspends the transmission of the connection request to the base station BS, thereby reducing the processing load of the base station BS, suppressing the congestion of the network N, and suppressing the battery consumption of the communication apparatus T.

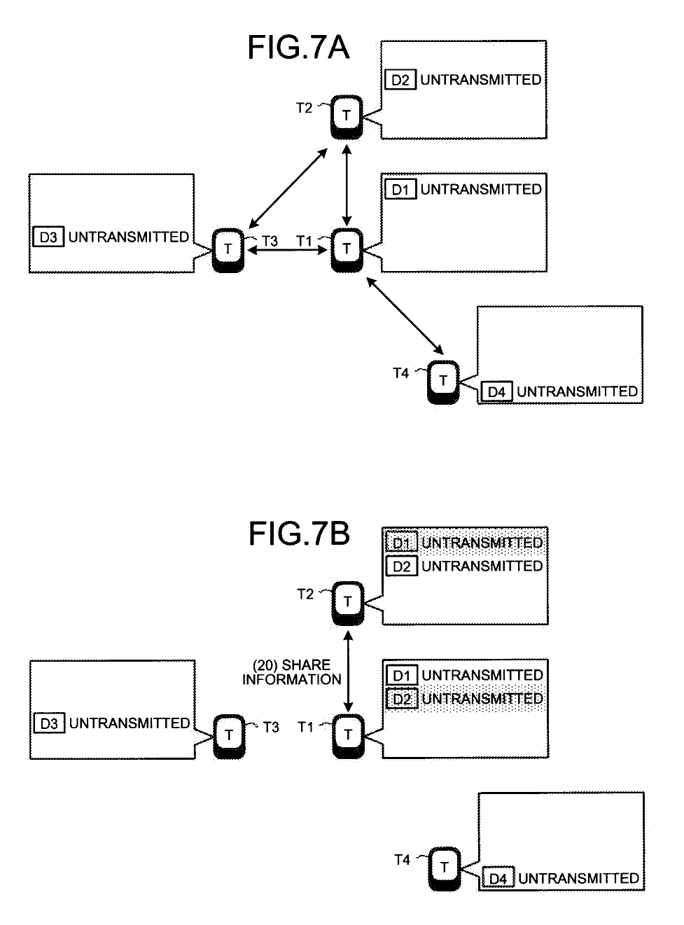

A specific example of a congestion suppression process performed by the communication apparatus T is described next with reference to FIGS. 7A to 13. The congestion suppression process includes an information distribution process of exchanging the data stored in the communication apparatus T and the information indicating whether the data have been transmitted. The congestion suppression process also includes a process of executing the connection process to the network N if the result of the information distribution process indicates untransmitted data are present in the communication apparatus T, and transmitting the data to the destination. The congestion suppression process also includes a process of suspending the connection process to the network N if the data have been successfully transmitted from the communication apparatus T or information indicating the data have been transmitted is received in the information distribution process.

In the congestion suppression process, the communication apparatus T executes the connection process to the network N in cooperation with the other communication apparatuses T in the communication area and tries to transmit the data to the destination, thereby improving the success rate of data transmission. In the congestion suppression process, the communication apparatus T suspends the transmission of the connection request to the base station BS performed in the connection process if the data stored in the communication apparatus T have been transmitted, thereby reducing the processing load of the base station BS and suppressing the congestion of the network N.

FIGS. 7A to 13 are diagrams of a specific example of the congestion suppression process. As depicted in FIG. 7A, communication apparatuses T2 to T4 are located in the communication area of the communication apparatus T1. Communication apparatuses T1 and T3 are located in the communication area of the communication apparatus T2. Communication apparatuses T1 and T2 are located in the communication area of the communication apparatus T3. Communication apparatus T1 is located in the communication area of the communication apparatus T4.

The communication apparatus T starts the congestion suppression process to suppress the congestion of the network N when, for example, a disaster warning such as the Earthquake Early Warning is received. The communication apparatus T may execute the congestion suppression process when a notification of a possible congestion of the network N is received from the communication service provider, or when a start instruction is input from a user.

The communication apparatus T1 stores therein the data D1 addressed to the apparatus S in the network N and the information indicating the data D1 have not yet been transmitted. The communication apparatus T2 stores therein the data D2 addressed to the apparatus S in the network N and the information indicating the data D2 have not yet been transmitted. The communication apparatus T3 stores therein the data D3 addressed to the apparatus S in the network N and the information indicating the data D3 have not yet been transmitted. The communication apparatus T4 stores therein data D4 addressed to the apparatus S in the network N and information indicating the data D4 have not yet been transmitted. For example, information indicating the states of the communication apparatuses T1 to T4 generated upon reception of the disaster warning, or data input from the user of the communication apparatuses T1 to T4 through the input device 205, is employed as the data D1 to D4.

As depicted in FIG. 7B, (20) the communication apparatuses T1 and T2 located in the other's communication area pair with each other by the inter-device wireless transceiver 203. The communication apparatus T1 transmits to the communication apparatus T2 by the inter-device wireless transceiver 203, the data D1 stored therein and the information indicating the data D1 have not yet been transmitted. The communication apparatus T2 receives and stores therein the data and the information from the communication apparatus T1 by the inter-device wireless transceiver 203.

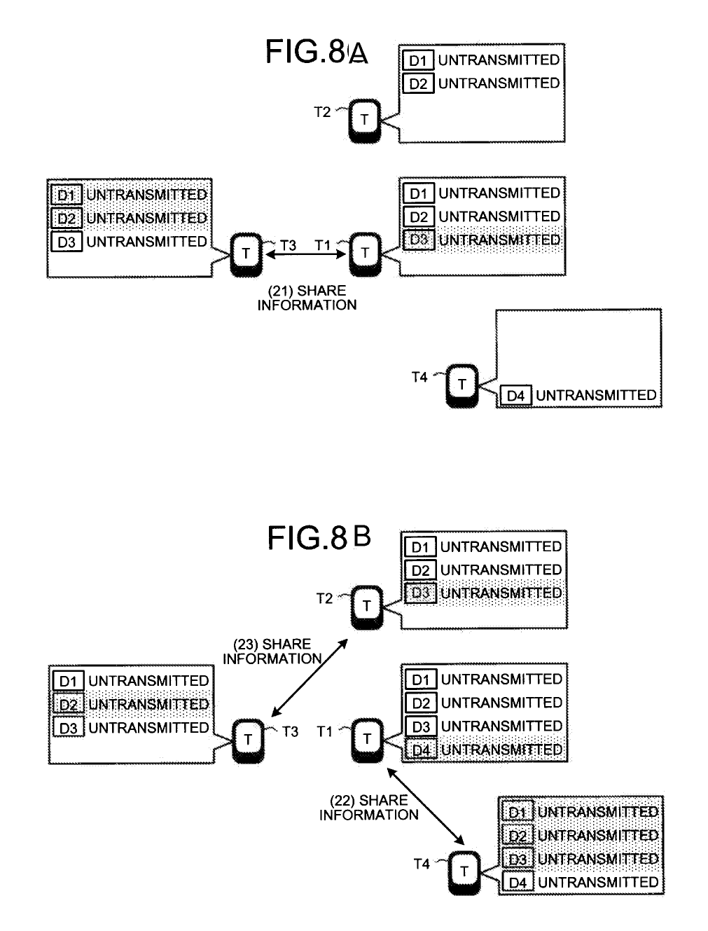

The communication apparatus T2 transmits to the communication apparatus T1 by the inter-device wireless transceiver 203, the data D2 stored therein and the information indicating the data D2 have not yet been transmitted. The communication apparatus T1 receives and stores therein the data and the information from the communication apparatus T2 by the inter-device wireless transceiver 203. The process then transitions to FIG. 8A.

As depicted in FIG. 8A, (21) the communication apparatuses T1 and T3 located in the other's communication area pair with each other by the inter-device wireless transceiver 203. The communication apparatus T1 transmits to the communication apparatus T3 by the inter-device wireless transceiver 203, the data D1 and D2 stored therein and the information indicating the data D1 and D2 have not yet been transmitted. The communication apparatus T3 receives and stores therein the data and the information from the communication apparatus T1 by the inter-device wireless transceiver 203.

The communication apparatus T3 transmits to the communication apparatus T1 by the inter-device wireless transceiver 203, the data D3 stored therein and the information indicating the data D3 have not yet been transmitted. The communication apparatus T1 receives the data and the information from the communication apparatus T3 by the inter-device wireless transceiver 203. The process then transitions to FIG. 8B. The communication apparatus T1 stores therein the received data and the information.

As depicted in FIG. 8B, (22) the communication apparatuses T1 and T4 located in the other's communication area pair with each other by the inter-device wireless transceiver 203. The communication apparatus T1 transmits to the communication apparatus T4 by the inter-device wireless transceiver 203, the data D1 to D3 stored therein and the information indicating the data D1 to D3 have not yet been transmitted. The communication apparatus T4 receives and stores therein the data and the information from the communication apparatus T1 by the inter-device wireless transceiver 203.

The communication apparatus T4 transmits to the communication apparatus T1 by the inter-device wireless transceiver 203, the data D4 stored therein and the information indicating the data D4 have not yet been transmitted. The communication apparatus T1 receives and stores therein the data and the information from the communication apparatus T4 by the inter-device wireless transceiver 203.

(23) The communication apparatuses T2 and T3 located in the other's communication area pair with each other by the inter-device wireless transceiver 203. The communication apparatus T2 transmits to the communication apparatus T3 by the inter-device wireless transceiver 203, the data D1 and D2 stored therein and the information indicating the data D1 and D2 have not yet been transmitted. The communication apparatus T3 receives the data and the information from the communication apparatus T2, but does not store therein the data and the information since the data and the information have been already stored.

The communication apparatus T3 transmits to the communication apparatus T2 by the inter-device wireless transceiver 203, the data D1 to D3 stored therein and the information indicating the data D1 to D3 have not yet been transmitted. The communication apparatus T2 receives the data and the information from the communication apparatus T3 by the inter-device wireless transceiver 203 and stores therein, among the received data and information, only the data D3 and the information indicating the data D3 have not yet been transmitted that have not yet been stored.

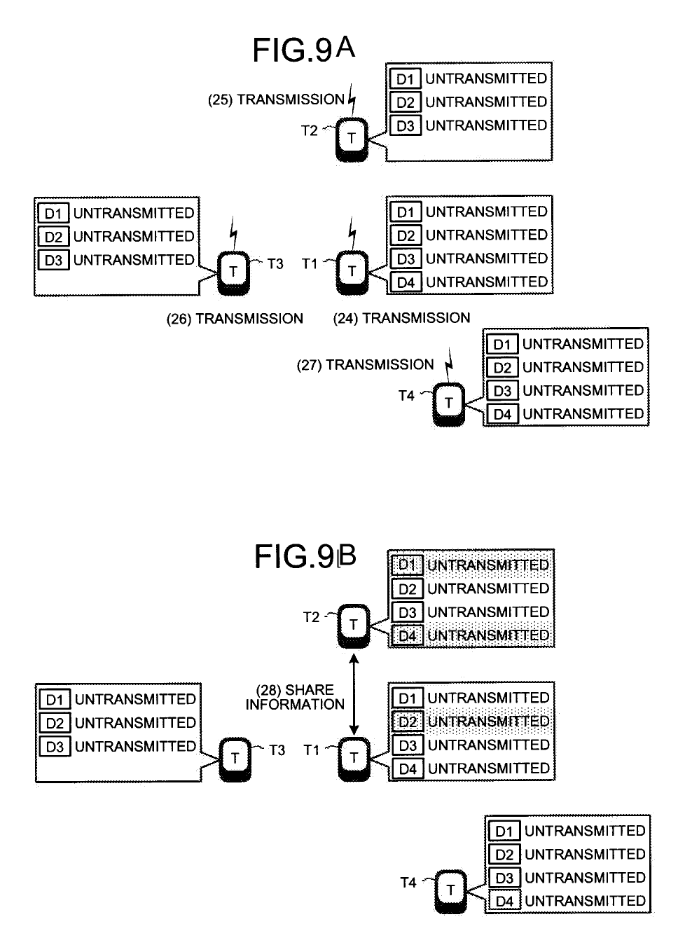

As depicted in FIGS. 7B to 8B, the communication apparatuses T1 to T4 exchange the data stored therein and the information indicating whether the data have been transmitted, whereby the communication apparatuses T1 to T4 have the identical data and information indicating whether the data have been transmitted. The process then transitions to FIG. 9A.

As depicted in FIG. 9A, (24) the communication apparatus T1 starts to transmit the data D1 to D4 to the destination upon completion of the information distribution process for the communication apparatuses T in the communication area, since the data D1 to D4 stored therein have not yet been transmitted. For example, the communication apparatus T1 executes the connection process to the network N via the base station BS, and transmits the data D1 to D4 to the destination after being connected to the network N. However, it is assumed that the communication apparatus T1 has failed to connect to the network N, and thus failed to transmit the data D1 to D4 to the destination.

(25) The communication apparatus T2 starts to transmit the data D1 to D3 to the destination upon completion of the information distribution process for the communication apparatuses T in the communication area, since the data D1 to D3 stored therein have not yet been transmitted. For example, the communication apparatus T2 executes the connection process to the network N via the base station BS, and transmits the data D1 to D3 to the destination after being connected to the network N. However, it is assumed that the communication apparatus T2 has failed to connect to the network N, and thus failed to transmit the data D1 to D3 to the destination.

(26) The communication apparatus T3 starts to transmit the data D1 to D3 to the destination upon completion of the information distribution process for the communication apparatuses T in the communication area, since the data D1 to D3 stored therein have not yet been transmitted. For example, the communication apparatus T3 executes the connection process to the network N via the base station BS, and transmits the data D1 to D3 to the destination after being connected to the network N. However, it is assumed that the communication apparatus T3 has failed to connect to the network N, and thus failed to transmit the data D1 to D3 to the destination.

(27) The communication apparatus T4 starts to transmit the data D1 to D4 to the destination upon completion of the information distribution process for the communication apparatuses T in the communication area, since the data D1 to D4 stored therein have not yet been transmitted. For example, the communication apparatus T4 executes the connection process to the network N via the base station BS, and transmits the data D1 to D4 to the destination after being connected to the network N. However, it is assumed that the communication apparatus T4 has failed to connect to the network N, and thus failed to transmit the data D1 to D4 to the destination. The process then transitions to FIG. 9B.

As depicted in FIG. 9B, (28) the communication apparatuses T1 and T2 located in the other's communication area pair with each other by the inter-device wireless transceiver 203. The communication apparatus T1 transmits to the communication apparatus T2 by the inter-device wireless transceiver 203, the data D1 to D4 stored therein and the information indicating the data D1 to D4 have not yet been transmitted. The communication apparatus T2 receives the data and the information from the communication apparatus T1 by the inter-device wireless transceiver 203 and stores therein, among the received data and information, only the data D4 and the information indicating the data D4 have not yet been transmitted that have not yet been stored.

The communication apparatus T2 transmits to the communication apparatus T1 by the inter-device wireless transceiver 203, the data D1 to D3 stored therein and the information indicating the data D1 to D3 have not yet been transmitted. The communication apparatus T1 receives the data and the information from the communication apparatus T2 by the inter-device wireless transceiver 203, but does not store therein the data and the information since the data and the information have been already stored.

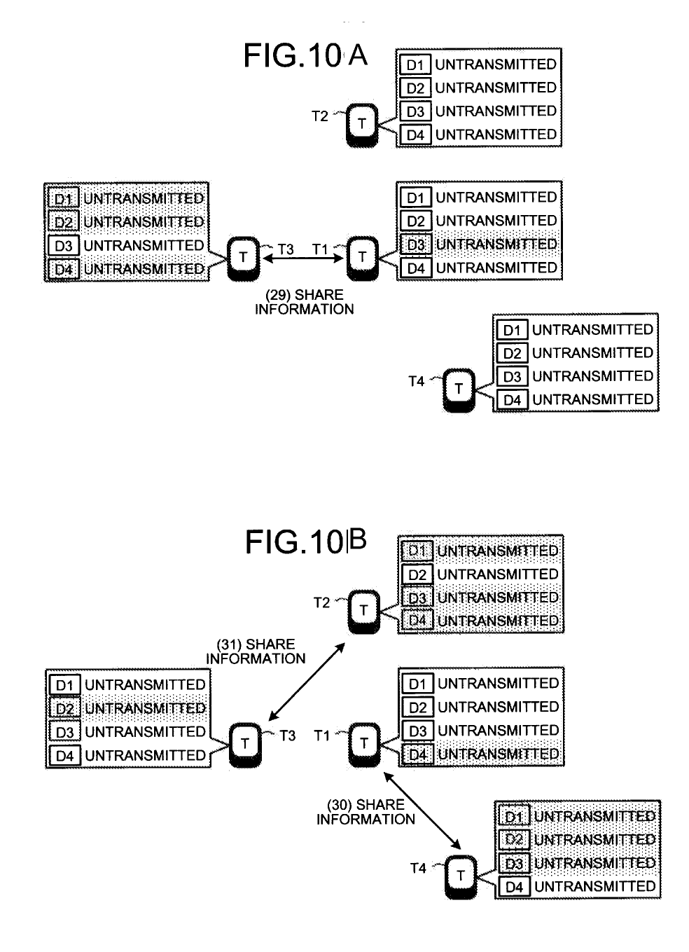

A new communication apparatus T (not depicted) other than the communication apparatuses T1 to T4 may enter the communication area of the communication apparatus T1 when the process transitions to FIG. 9B. In this case, the communication apparatus T1 executes the information distribution process for the new communication apparatus T and exchanges data. However, the communication apparatus T1 discards the data received from the communication apparatus T and notifies the communication apparatus T that the data cannot be held if the number of communication apparatuses T to exchange data is set up to 4. In this case, the new communication apparatus T executes the connection process to the network N by its own. The process then transitions to FIG. 10A.

As depicted in FIG. 10A, (29) the communication apparatuses T1 and T3 located in the other's communication area pair with each other by the inter-device wireless transceiver 203. The communication apparatus T1 transmits to the communication apparatus T3 by the inter-device wireless transceiver 203, the data D1 to D4 stored therein and the information indicating the data D1 to D4 have not yet been transmitted. The communication apparatus T3 receives the data and the information from the communication apparatus T1 by the inter-device wireless transceiver 203 and stores therein, among the received data and information, only the data D4 and the information indicating the data D4 have not yet been transmitted that have not yet been stored.

The communication apparatus T3 transmits to the communication apparatus T1 by the inter-device wireless transceiver 203, the data D1 to D3 stored therein and the information indicating the data D1 to D3 have not yet been transmitted. The communication apparatus T1 receives the data and the information from the communication apparatus T3 by the inter-device wireless transceiver 203, but does not store therein the data and the information since the data and the information have been already stored. The process then transitions to FIG. 10B.

As depicted in FIG. 10B, (30) the communication apparatuses T1 and T4 located in the other's communication area pair with each other by the inter-device wireless transceiver 203. The communication apparatus T1 transmits to the communication apparatus T4 by the inter-device wireless transceiver 203, the data D1 to D4 stored therein and the information indicating the data D1 to D4 have not yet been transmitted. The communication apparatus T4 receives the data and the information from the communication apparatus T1 by the inter-device wireless transceiver 203, but does not store therein the data and the information since the data and the information have been already stored.

The communication apparatus T4 transmits to the communication apparatus T1 by the inter-device wireless transceiver 203, the data D1 to D4 stored therein and the information indicating the data D1 to D4 have not yet been transmitted. The communication apparatus T1 receives the data and the information from the communication apparatus T4 by the inter-device wireless transceiver 203, but does not store therein the data and the information since the data and the information have been already stored.

(31) The communication apparatuses T2 and T3 located in the other's communication area pair with each other by the inter-device wireless transceiver 203. The communication apparatus T2 transmits to the communication apparatus T3 by the inter-device wireless transceiver 203, the data D1 to D4 stored therein and the information indicating the data D1 to D4 have not yet been transmitted. The communication apparatus T3 receives the data and the information from the communication apparatus T2 by the inter-device wireless transceiver 203, but does not store therein the data and the information since the data and the information have been already stored.

The communication apparatus T3 transmits to the communication apparatus T2 by the inter-device wireless transceiver 203, the data D1 to D4 stored therein and the information indicating the data D1 to D4 have not yet been transmitted. The communication apparatus T2 receives the data and the information from the communication apparatus T3 by the inter-device wireless transceiver 203, but does not store therein the data and the information since the data and the information have been already stored.

As depicted in FIGS. 9B to 10B, the communication apparatuses T1 to T4 exchange the data stored therein and the information indicating whether the data have been transmitted, whereby the communication apparatuses T1 to T4 have the identical data and information indicating whether the data have been transmitted.

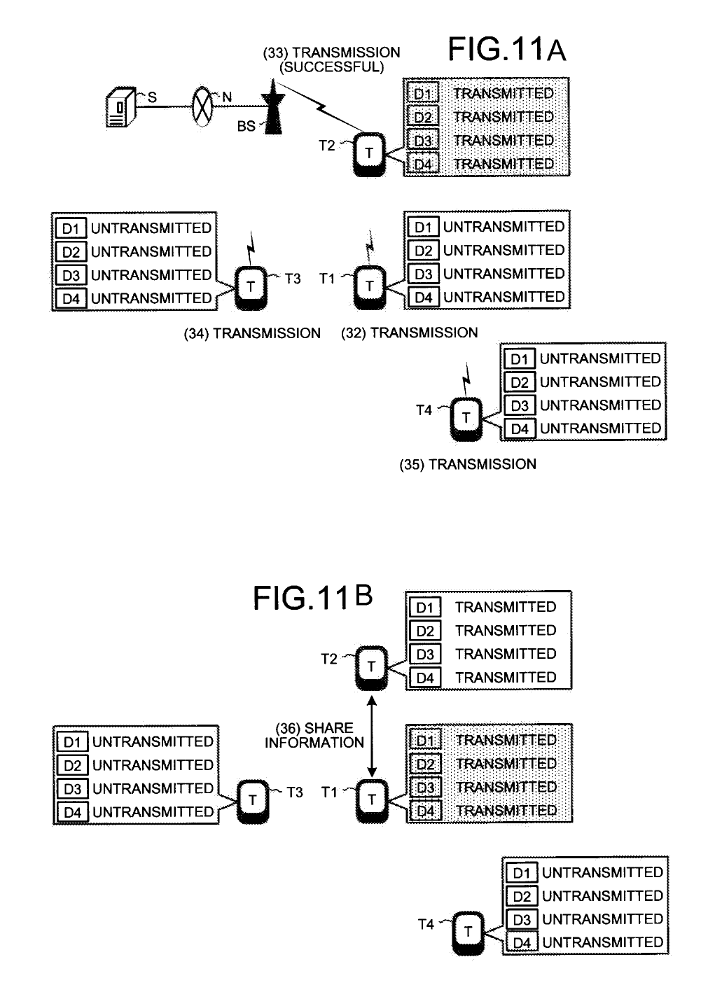

If the state of the communication apparatus T1 changes before the transition to FIG. 9B, the communication apparatus T1 may generate new data indicating the new state and update the data D1 to the new data. In this case, the communication apparatus T1 transmits to the communication apparatuses T2 to T4 by the inter-device wireless transceiver 203, the new data and information indicating the new data have not yet been transmitted in the processes depicted in FIGS. 9B to 10B. The communication apparatuses T2 to T4 receive the new data from the communication apparatus T1, compare time stamps indicating the time when the data D1 and the new data were transmitted, respectively, determine the new data are newer than the data D1, and update the data D1 to the new data. The process then transitions to FIG. 11A.

As depicted in FIG. 11A, (32) the communication apparatus T1 starts to transmit the data D1 to D4 to the destination upon completion of the information distribution process for the communication apparatuses T in the communication area, since the data D1 to D4 stored therein have not yet been transmitted. For example, the communication apparatus T1 executes the connection process to the network N via the base station BS, and transmits the data D1 to D4 to the destination after being connected to the network N. However, it is assumed that the communication apparatus T1 has failed to connect to the network N, and thus failed to transmit the data D1 to D4 to the destination.

(33) The communication apparatus T2 starts to transmit the data D1 to D4 to the destination upon completion of the information distribution process for the communication apparatuses T in the communication area, since the data D1 to D4 stored therein have not yet been transmitted. For example, the communication apparatus T2 executes the connection process to the network N via the base station BS, and transmits the data D1 to D4 to the destination after being connected to the network N. It is assumed that the communication apparatus T2 has successfully connected to the network N, and thus transmitted the data D1 to D4 to the destination.

(34) The communication apparatus T3 starts to transmit the data D1 to D4 to the destination upon completion of the information distribution process for the communication apparatuses T in the communication area, since the data D1 to D4 stored therein have not yet been transmitted. For example, the communication apparatus T3 executes the connection process to the network N via the base station BS, and transmits the data D1 to D4 to the destination after being connected to the network N. However, it is assumed that the communication apparatus T3 has failed to connect to the network N, and thus failed to transmit the data D1 to D4 to the destination.

(35) The communication apparatus T4 starts to transmit the data D1 to D4 to the destination upon completion of the information distribution process for the communication apparatuses T in the communication area, since the data D1 to D4 stored therein have not yet been transmitted. For example, the communication apparatus T4 executes the connection process to the network N via the base station BS, and transmits the data D1 to D4 to the destination after being connected to the network N. However, it is assumed that the communication apparatus T4 has failed to connect to the network N, and thus failed to transmit the data D1 to D4 to the destination.

As depicted in FIG. 11A, the data D1 to D4 can be transmitted to the destination if at least one communication apparatus T of the communication apparatuses T1 to T4 has successfully connected to the communication apparatus T. For example, the base station BS near the communication apparatus T2 may operate properly even when the base stations BS near the communication apparatuses T1, T3, and T4 are in a failure. In this case, the data D1 to D4 to be transmitted by the communication apparatuses T1 to T4 can be transmitted by the representative communication apparatus T2 provided the communication apparatus T2 can connect to the network N, even when the communication apparatuses T1, T3, and T4 cannot connect to the network N.

Further, no bandwidth restriction may be set for the base station BS provided by the communication service provider of the communication apparatus T2, even when bandwidth restriction is set for the base stations BS provided by the communication service provider of the communication apparatuses T1, T3, and T4. In this case, the data D1 to D4 to be transmitted by the communication apparatuses T1 to T4 can be transmitted by the representative communication apparatus T2 provided the communication apparatus T2 can connect to the network N, even when the communication apparatuses T1, T3, and T4 cannot connect to the network N.

Thus, the communication apparatus T executes the connection process to the network N and transmits the data to the destination in cooperation with the other communication apparatuses T in the communication area, thereby improving the success rate of data transmission. The process then transitions to FIG. 11B.

As depicted in FIG. 11B, (36) the communication apparatuses T1 and T2 located in the other's communication area pair with each other by the inter-device wireless transceiver 203. The communication apparatus T1 transmits to the communication apparatus T2 by the inter-device wireless transceiver 203, the data D1 to D4 stored therein and the information indicating the data D1 to D4 have not yet been transmitted. The communication apparatus T2 receives the data and the information from the communication apparatus T1 by the inter-device wireless transceiver 203, but does not store therein the data and the information since the data and the information have been already transmitted.

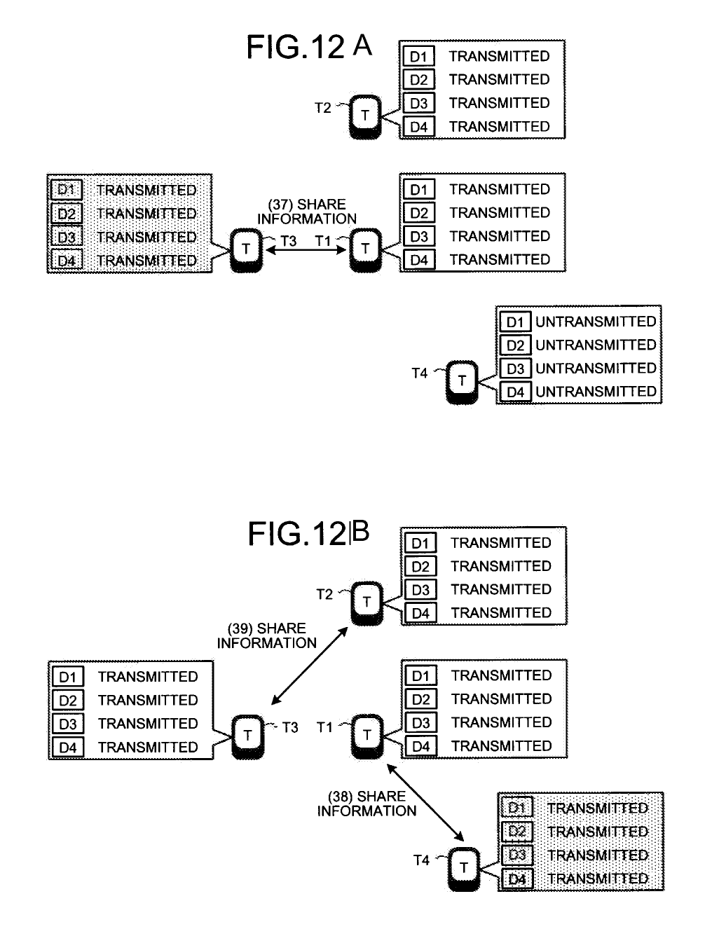

The communication apparatus T2 transmits to the communication apparatus T1 by the inter-device wireless transceiver 203, the data D1 to D4 stored therein and the information indicating the data D1 to D4 have been transmitted. The communication apparatus T1 receives the data and the information from the communication apparatus T2 by the inter-device wireless transceiver 203, and updates the information stored therein and indicating the data D1 to D4 have not yet been transmitted to the information received from the communication apparatus T2 and indicating the data D1 to D4 have been transmitted. The process then transitions to FIG. 12A.

As depicted in FIG. 12A, (37) the communication apparatuses T1 and T3 located in the other's communication area pair with each other by the inter-device wireless transceiver 203. The communication apparatus T1 transmits to the communication apparatus T3 by the inter-device wireless transceiver 203, the data D1 to D4 stored therein and the information indicating the data D1 to D4 have been transmitted. The communication apparatus T3 receives the data and the information from the communication apparatus T1 by the inter-device wireless transceiver 203, and updates the information stored therein and indicating the data D1 to D4 have not yet been transmitted to the information received from the communication apparatus T1 and indicating the data D1 to D4 have been transmitted.

The communication apparatus T3 transmits to the communication apparatus T1 by the inter-device wireless transceiver 203, the data D1 to D4 stored therein and the information indicating the data D1 to D4 have not yet been transmitted. The communication apparatus T1 receives the data and the information from the communication apparatus T3 by the inter-device wireless transceiver 203. The process then transitions to FIG. 12B.

As depicted in FIG. 12B, (38) the communication apparatuses T1 and T4 located in the other's communication area pair with each other by the inter-device wireless transceiver 203. The communication apparatus T1 transmits to the communication apparatus T4 by the inter-device wireless transceiver 203, the data D1 to D4 stored therein and the information indicating the data D1 to D4 have been transmitted. The communication apparatus T4 receives the data and the information from the communication apparatus T1 by the inter-device wireless transceiver 203, and updates the information stored therein and indicating the data D1 to D4 have not yet been transmitted to the information received from the communication apparatus T1 and indicating the data D1 to D4 have been transmitted.

The communication apparatus T4 transmits to the communication apparatus T1 by the inter-device wireless transceiver 203, the data D1 to D4 stored therein and the information indicating the data D1 to D4 have not yet been transmitted. The communication apparatus T1 receives the data and the information from the communication apparatus T4 by the inter-device wireless transceiver 203.

(39) The communication apparatuses T2 and T3 located in the other's communication area pair with each other by the inter-device wireless transceiver 203. The communication apparatus T2 transmits to the communication apparatus T3 by the inter-device wireless transceiver 203, the data D1 to D4 stored therein and the information indicating the data D1 to D4 have been transmitted. The communication apparatus T3 receives the data and the information from the communication apparatus T2 by the inter-device wireless transceiver 203.

The communication apparatus T3 transmits to the communication apparatus T2 by the inter-device wireless transceiver 203, the data D1 to D4 stored therein and the information indicating the data D1 to D4 have been transmitted. The communication apparatus T2 receives the data and the information from the communication apparatus T3 by the inter-device wireless transceiver 203.

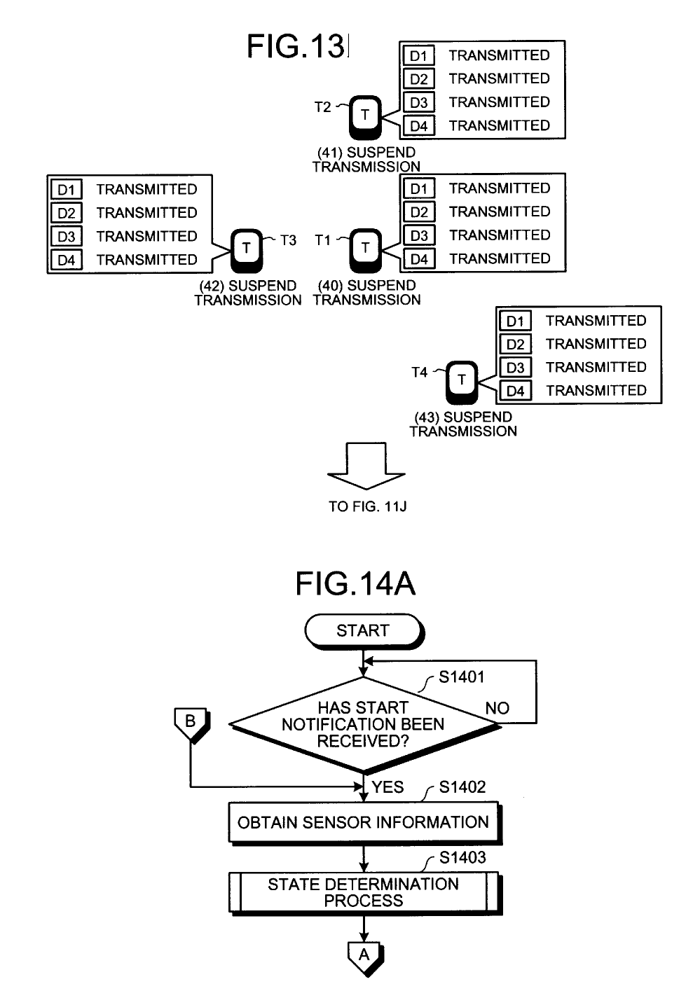

As depicted in FIGS. 11B to 12B, the communication apparatuses T1 to T4 exchange the data stored therein and the information indicating whether the data have been transmitted, whereby the communication apparatuses T1 to T4 have the information indicating the data D1 to D4 have been transmitted. The process then transitions to FIG. 13.

As depicted in FIG. 13, (40) the communication apparatus T1 determines whether the data D1 to D4 stored therein have been transmitted to the destination upon completion of the information distribution process for the communication apparatuses T in the communication area. Here, the communication apparatus T1 suspends the connection process to the network N via the base station BS and does not transmit the data D1 to D4 to the destination, since the data D1 to D4 stored therein have been transmitted to the destination.

(41) The communication apparatus T2 determines whether the data D1 to D4 stored therein have been transmitted to the destination upon completion of the information distribution process for the communication apparatuses T in the communication area. Here, the communication apparatus T2 suspends the connection process to the network N via the base station BS and does not transmit the data D1 to D4 to the destination, since the data D1 to D4 stored therein have been transmitted to the destination.

(42) The communication apparatus T3 determines whether the data D1 to D4 stored therein have been transmitted to the destination upon completion of the information distribution process for the communication apparatuses T in the communication area. Here, the communication apparatus T3 suspends the connection process to the network N via the base station BS and does not transmit the data Dl to D4 to the destination, since the data D1 to D4 stored therein have been transmitted to the destination.

(43) The communication apparatus T4 determines whether the data D1 to D4 stored therein have been transmitted to the destination upon completion of the information distribution process for the communication apparatuses T in the communication area. Here, the communication apparatus T4 suspends the connection process to the network N via the base station BS and does not transmit the data D1 to D4 to the destination, since the data D1 to D4 stored therein have been transmitted to the destination. The process then returns to FIG. 11B.

The communication apparatuses T1 to T4 then repeat the processes of FIGS. 11B to 13. If the state of the communication apparatus T1 changes when the process returns to FIG. 11B, the communication apparatus T1 may generate new data indicating the new state and update the data D1 to the new data.

In this case, the communication apparatus T1 transmits to the communication apparatuses T2 to T4 by the inter-device wireless transceiver 203, the new data and information indicating the new data have not yet been transmitted. The communication apparatuses T2 to T4 receive the new data from the communication apparatus T1, compare time stamps indicating the time when the data D1 and the new data were transmitted, respectively, determine the new data are newer than the data D1, and update the data D1 to the new data. The communication apparatuses T1 to T4 execute the connection process to the network N to transmit the untransmitted new data to the destination, and transmit the new data to the destination after being connected to the network N.

In FIG. 9A, the communication apparatus T2 may successfully transmit the data D1 to D3 to the destination. In this case, as a result of the information distribution process depicted in FIGS. 9B to 10B, the communication apparatuses T1 to T4 store the data D1 to D4, information indicating the data D1 to D3 have been transmitted, and information indicating the data D4 have not yet been transmitted. In FIG. 11A, the communication apparatuses T1 to T4 start to transmit the data D4 to the destination since untransmitted data D4 are present in the data D1 to D4 stored therein.

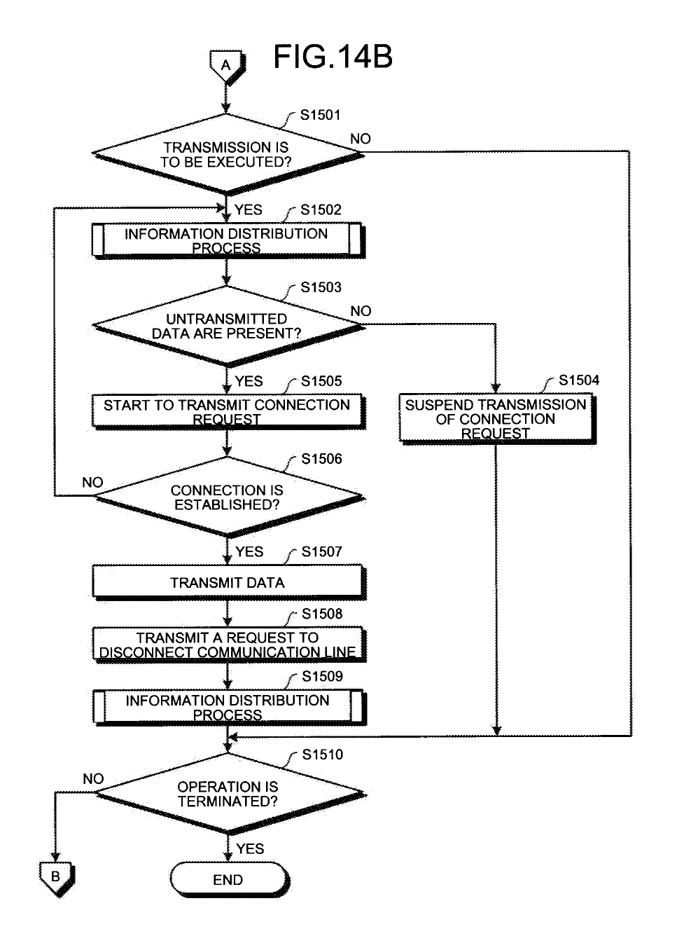

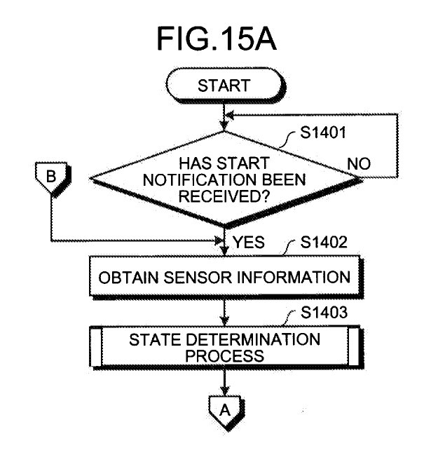

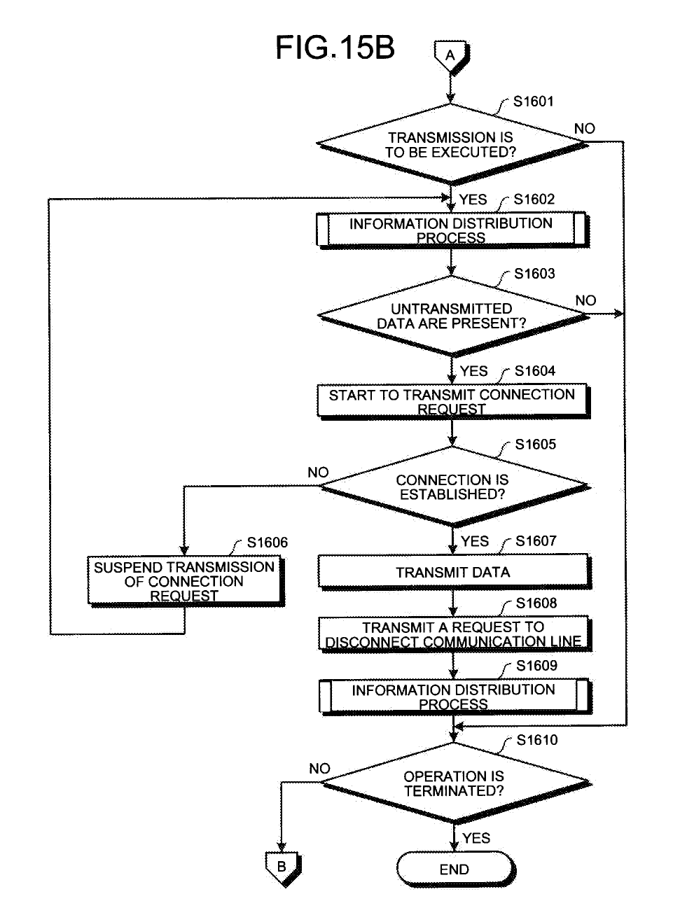

Details of a first example of the congestion suppression process are described next with reference to FIGS. 14 and 15. In the first example, the communication apparatus T suspends the ongoing connection process to the network N if untransmitted data are not present any more in the data stored therein. Thus, the communication apparatus T suspends the transmission of the connection request to the base station BS, thereby reducing the processing load of the base station BS and suppressing the congestion of the network N.

FIGS. 14 and 15 are flowcharts of the first example of the congestion suppression process. As depicted in FIG. 14A, the communication apparatus T determines whether a start notification is received (step S1401). For example, the communication apparatus T determines the start notification is received upon reception of a disaster warning such as the Earthquake Early Warning or an input of a start instruction from a user.

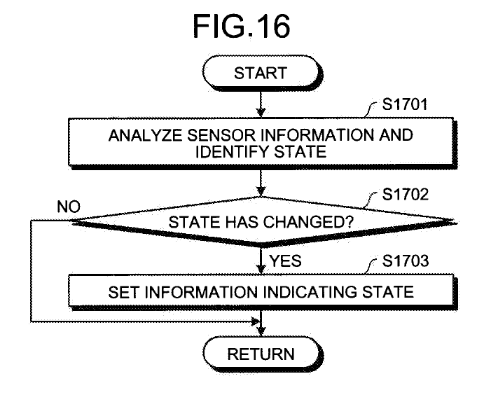

If no start notification is received (step S1401: NO), the communication apparatus T waits for the start notification at step S1401. If a start notification is received (step S1401: YES), the communication apparatus T obtains sensor information from the sensors S1 to Sn (step S1402), executes a state determination process described later with reference to FIG. 16 (step S1403), and transitions to step S1501 of FIG. 14B.

As depicted in FIG. 14B, the communication apparatus T determines whether to execute transmission (step S1501). The communication apparatus T determines to execute the transmission if, for example, a given period of time has not passed since the start notification. Otherwise (step S1501: NO), the communication apparatus T transitions to step S1510.

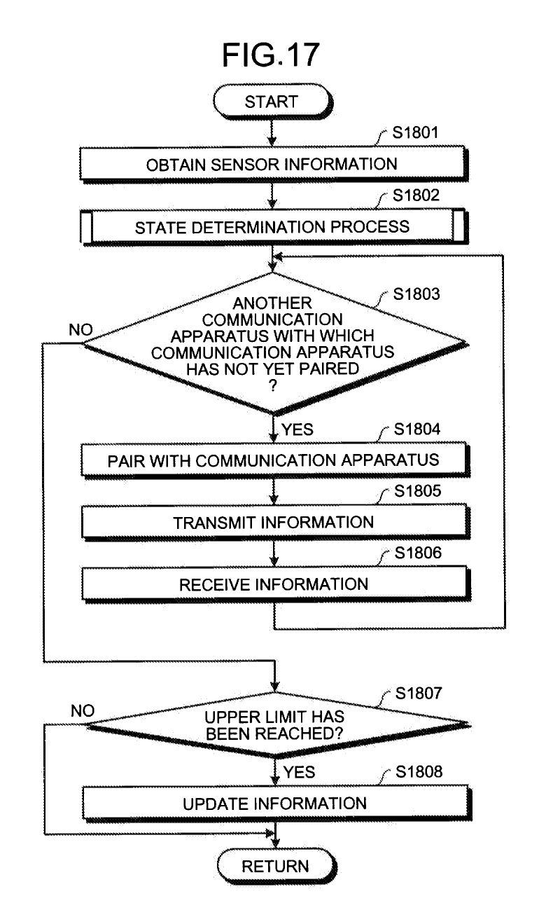

If the communication apparatus T determines to execute the transmission (step S1501: YES), the communication apparatus T executes an information distribution process described later with reference to FIG. 17 (step S1502), and determines whether untransmitted data are present in the data stored therein (step S1503). If not (step S1503: NO), the communication apparatus T suspends the transmission of the connection request to the base station BS (step S1504), and transitions to step S1510.

If untransmitted data are present (step S1503: YES), the communication apparatus T executes the transmission of the connection request to the base station BS (step S1505), and determines whether the connection to the base station BS is established (step S1506). If not (step S1506: NO), the communication apparatus T returns to step S1502.

If the connection is established (step S1506: YES), the communication apparatus T transmits the untransmitted data to the destination via the base station BS (step S1507), transmits a request to disconnect the connected communication line to the base station BS (step S1508), and executes an information distribution process described later with reference to FIG. 17 (step S1509).

The communication apparatus T determines whether to terminate operation (step S1510). For example, the communication apparatus T determines to terminate the operation when a cancel notification of the disaster warning is received, or when a given period of time has passed since the reception of the disaster warning, or when an instruction to terminate operation is input from a user.

If the operation is not terminated (step S1510: NO), the communication apparatus T transitions to step S1402 of FIG. 14A. If the operation is terminated (step S1510: YES), the communication apparatus T terminates the congestion suppression process.

Thus, the communication apparatus T transmits to the other communication apparatuses T, if the untransmitted data are successfully transmitted to the destination, information indicating the untransmitted data have been transmitted. The communication apparatus T determines, if the information indicating the untransmitted data have been transmitted, the data need not to be transmitted therefrom and suspends the transmission of the connection request to the base station BS. Thus, the transmission of the connection request by the communication apparatus T to the base station BS is suspended, thereby reducing the processing load of the base station BS and suppressing the congestion of the network N.

Details of a second example of the congestion suppression process are described next with reference to FIG. 15B. In the second example, the communication apparatus T does not continue and suspends the connection process if the connection to the network N by the connection process has failed. The communication apparatus T does not start the connection process to the network N if untransmitted data are not present any more in the data stored therein. Thus, the communication apparatus T does not transmit the connection request to the base station BS after the untransmitted data are not present any more in the data stored therein, thereby reducing the processing load of the base station BS and suppressing the congestion of the network N.

FIG. 15B is a flowchart of the second example of the congestion suppression process. Similar to the first example, the processes depicted in FIG. 15A (step S1401 to step S1403) are executed in the second example. The communication apparatus T transitions to S1601 of FIG. 15B after step S1403.

As depicted in FIG. 15B, the communication apparatus T determines whether to execute transmission (step S1601). If not (step S1601: NO), the communication apparatus T transitions to step S1610.

If the communication apparatus T determines to execute the transmission (step S1601: YES), the communication apparatus T executes an information distribution process described later with reference to FIG. 17 (step S1602), and determines whether untransmitted data are present in the data stored therein (step S1603). If not (step S1603: NO), the communication apparatus T transitions to step S1610.

If untransmitted data are present (step S1603: YES), the communication apparatus T transmits the connection request to the base station BS (step S1604), and determines whether the connection to the base station BS has established (step S1605). If not (step S1605: NO), the communication apparatus T suspends the transmission of the connection request to the base station BS (step S1606), and returns to step S1602.

If the connection is established (step S1605: YES), the communication apparatus T transmits the untransmitted data to the destination via the base station BS (step S1607), transmits a request to disconnect the connected communication line to the base station BS (step S1608), and executes an information distribution process described with reference to FIG. 17 (step S1609).

The communication apparatus T determines whether to terminate operation (step S1610). If not (step S1610: NO), the communication apparatus T transitions to step S1402 of FIG. 14A.

If the communication apparatus T determines to terminate the operation (step S1610: YES), the communication apparatus T terminates the congestion suppression process. Thus, the communication apparatus T transmits to the other communication apparatuses T, when the untransmitted data are successfully transmitted to the destination, information indicating the untransmitted data have been transmitted. The communication apparatus T suspends the transmission of the connection request to the base station BS if the connection to the network N has failed. The communication apparatus T determines, when the information indicating the untransmitted data have been transmitted, the data need not to be transmitted therefrom and does not start the transmission of the connection request to the network N. Thus, the transmission of the connection request by the communication apparatus T to the base station BS is suspended, thereby reducing the processing load of the base station BS and suppressing the congestion of the network N.

Details of the state determination process executed by the communication apparatus T at step S1403 of FIG. 14A are described next with reference to FIG. 16.

FIG. 16 is a flowchart of the state determination process. As depicted in FIG. 16, the communication apparatus T identifies the state of the communication apparatus T by analyzing sensor information (step S1701), and determines whether the state has changed (step S1702). If not (step S1702: NO), the communication apparatus T terminates the state determination process.

If the state has changed (step S1702: YES), the communication apparatus T sets information identifying the identified state into the state information table 400 (step S1703), thereby terminating the state determination process. Thus, the communication apparatus T updates information indicating the state of the communication apparatus T and stored in the state information table 400 so as to indicate the latest state.

Details of the information distribution process executed by the communication apparatus T at steps S1502 and S1509 of FIG. 14B and steps S1602 and S1609 of FIG. 15B, and executed by the communication apparatuses T1 to T4 in FIGS. 7B to 8B, 9B to 10B, and 11B to 12B, are described next with reference to FIG. 17.

FIG. 17 is a flowchart of the information distribution process. As depicted in FIG. 17, the communication apparatus T obtains sensor information from the sensors S1 to Sn (step S1801), and executes the state determination process described with reference to FIG. 16 (step S1802).

The communication apparatus T determines whether another communication apparatus T is present with which the communication apparatus T has not yet paired (step S1803). If any other communication apparatus T is present (step S1803: YES), the communication apparatus T pairs with the other communication apparatus T by the inter-device wireless transceiver 203 (step S1804).

The communication apparatus T transmits to the other communication apparatus T by the inter-device wireless transceiver 203, information indicating the state of the communication apparatus T and information indicating whether the information has been transmitted (step S1805). The communication apparatus T receives from the other communication apparatus T by the inter-device wireless transceiver 203, information indicating the state of the other communication apparatus T and information indicating whether the information has been transmitted (step S1806), and adds the received information to the state information table 400, thereby returning to step S1803.

If no other communication apparatus T is present with which the communication apparatus T has not yet paired (step S1803: NO), the communication apparatus T determines whether the number of records stored in the state information table 400 has reached an upper limit of the number of apparatuses to be managed (step S1807). The upper limit is a threshold set as an upper limit of the number of records of the state information table 400 such that a free space is secured in the storage device 202 of the communication apparatus T.

If the upper limit has not yet been reached (step S1807: NO), the communication apparatus T terminates the information distribution process. If the upper limit has been reached (step S1807: YES), the communication apparatus T deletes a newer record(s) from the state information table 400 such that the number of records of the state information table 400 becomes equal to or less than the upper limit (step S1808), thereby terminating the information distribution process.

Thus, the communication apparatus T exchanges the data stored therein and the information indicating whether the information has been transmitted with the other communication apparatuses T in the communication area, whereby the communication apparatus T and the other communication apparatuses T in the communication area have the identical data and information indicating whether the data have been transmitted.

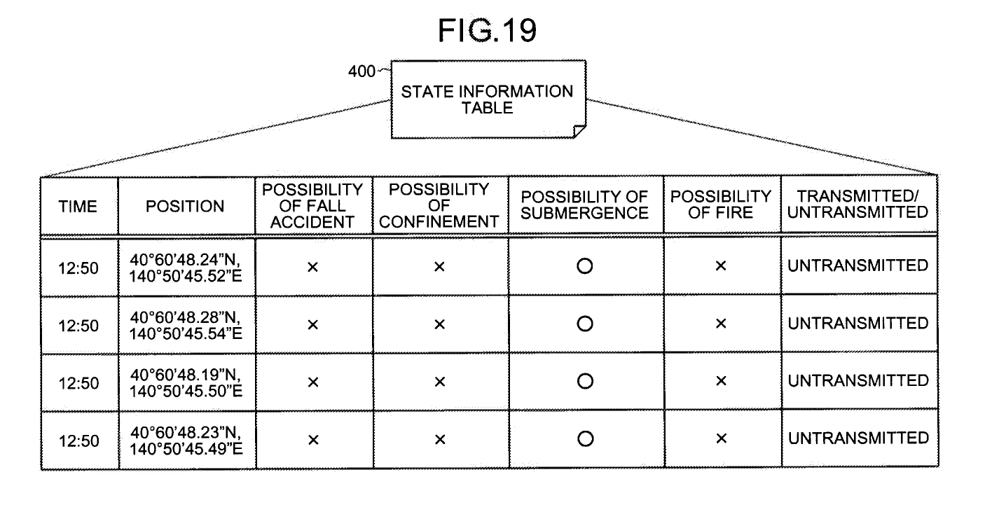

An example of the communication apparatus T applied to an automatic disaster warning apparatus is described next with reference to FIGS. 19 to 24. The automatic disaster warning apparatus identifies the state thereof upon reception of a disaster warning from a communication service provider, and transmits an emergency notification automatically if the state indicates the apparatus is suffering from a disaster. The emergency notification may be generated by speech synthesis if the recipient is a telephone incapable of packet communication. The communication apparatus T applied to the automatic disaster warning apparatus includes a velocity sensor S, an illumination sensor S, and a temperature sensor S as the sensors Si to Sn to identify the type of the disaster from which the apparatus is suffering.

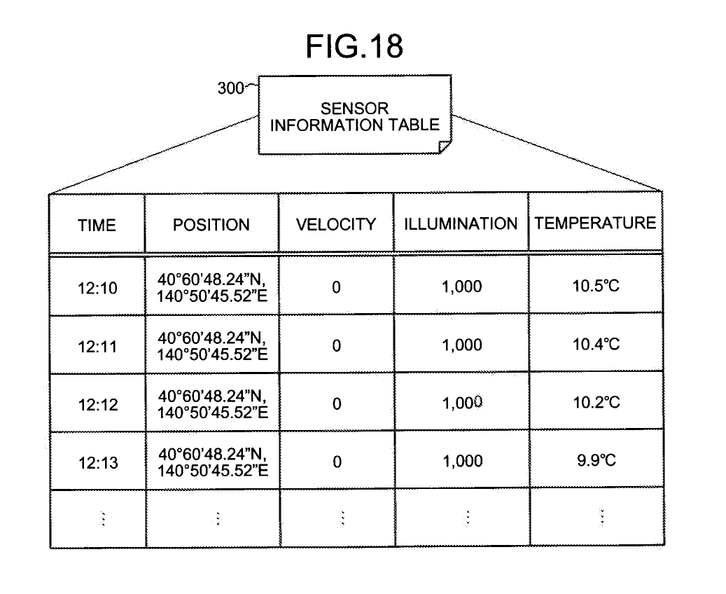

Contents of the sensor information table 300 applied to the automatic disaster warning apparatus are described with reference to FIG. 18. The sensor information table 300 is referred to for identifying the type of the disaster from which the communication apparatus T is suffering.

FIG. 18 is a diagram of an example of the contents of the sensor information table 300 of the communication apparatus T applied to the automatic disaster warning apparatus. As depicted in FIG. 18, the sensor information table 300 includes a position field, a velocity field, an illumination field, and a temperature field that are associated with a time field, and stores a record for each time when sensor information are obtained by the sensors Si to Sn. Contents of the time field and the position field are the same as those of FIG. 3, and thus description thereof is omitted.

The velocity field stores the velocity of the communication apparatus T obtained by the velocity sensor S. The unit of the velocity is m/s², for example. The illumination field stores the illumination around the communication apparatus T obtained by the illumination sensor S. The unit of the illumination is 1×, for example. The temperature field stores the temperature around the communication apparatus T obtained by the temperature sensor S. The unit of the temperature is Celsius, for example.

Contents of the state information table 400 of the communication apparatus T applied to the automatic disaster warning apparatus are described next with reference to FIG. 19. The state information table 400 is included in the communication apparatus T, and stores state information and whether the state information has been transmitted to the destination. The state information is data to be transmitted to the destination in the network N and is, for example, information indicating the type of the disaster from which the communication apparatus T is suffering. Thus, the state information stored in the state information table 400 is employed as the data D1 to D4 depicted in FIGS. 7 to 13.

FIG. 19 is a diagram of an example of the contents of the state information table 400 of the communication apparatus T applied to the automatic disaster warning apparatus. As depicted in FIG. 19, the state information table 400 includes a position field, a possibility-of-fall field, a possibility-of-confinement field, a possibility-of-submergence field, a possibility-of-fire field, and a transmitted/untransmitted field that are associated with a time field, and stores a record for each time when the state of the communication apparatus T is identified based on the sensor information. Contents of the time field and the position field are the same as those of FIG. 4, and thus description thereof is omitted.

The possibility-of-fall field stores the possibility of the communication apparatus T having fallen. For example, the communication apparatus T determines a fall accident may possibly have occurred if the position of the communication apparatus T does not change but the velocity is equal to or higher than a threshold, and stores information indicating the possibility in the possibility-of-fall field (represented by a circle in FIG. 19).

The possibility-of-confinement field stores the possibility of the communication apparatus T having been confined. For example, the communication apparatus T determines the communication apparatus T may possibly have been confined if the position thereof is included in the area where a disaster is occurring, it is daytime but the illumination is equal to or lower than a threshold, and the velocity is equal to or lower than a threshold, and stores information indicating the possibility in the possibility-of-confinement field (represented by a circle in FIG. 19).

The possibility-of-submergence field stores the possibility of the communication apparatus T having been submerged. For example, the communication apparatus T determines the communication apparatus T may possibly have been submerged if the position of the communication apparatus T is included in the area where a disaster is occurring (for example, an area for which a tsunami warning has been issued) and the temperature is equal to or lower than a threshold, and stores information indicating the possibility in the possibility-of-submergence field (represented by a circle in FIG. 19).

The possibility-of-fire field stores the possibility of the communication apparatus T being involved in a fire. For example, the communication apparatus T determines the communication apparatus T may possibly have been involved in a fire if the temperature is equal to or higher than a threshold, and stores information indicating the possibility in the possibility-of-fire field (represented by a circle in FIG. 19).

The transmitted/untransmitted field stores whether the state information has been transmitted. The state information is, for example, the contents of the time field, the position field, and one or more possibility-of-state fields.

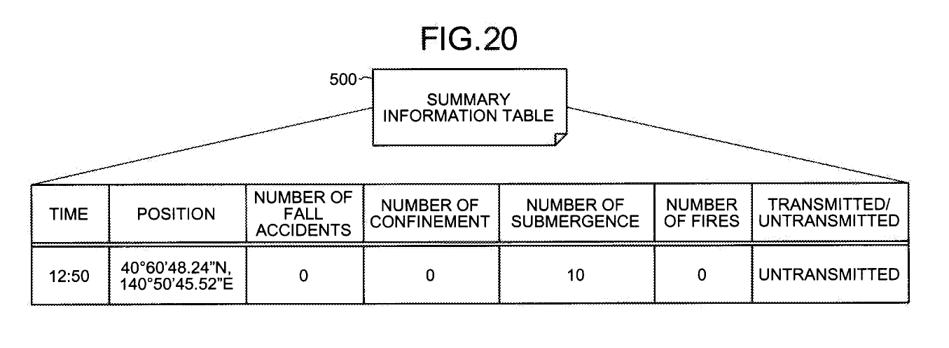

Contents of the summary information table 500 of the communication apparatus T applied to the automatic disaster warning apparatus are described next with reference to FIG. 20. The summary information table 500 is included in the communication apparatus T, and stores summary information and information indicating whether the summary information has been transmitted to the destination. The summary information is data to be transmitted to the destination in the network N, and indicates the number of communication apparatuses T suffering from each type of disaster. The summary information table 500 is implemented by the storage device 202.

FIG. 20 is a diagram of an example of contents of the summary information table 500 of the communication apparatus T applied to the automatic disaster warning apparatus. As depicted in FIG. 20, the summary information table 500 includes a position field, a number-of-fall field, a number-of-confinement field, a number-of-submergence field, and a number-of-fire field that are associated with a time field, and stores a record for each time when the summary information is generated based on the state information. Contents of the time field and the position field are the same as those of FIG. 5, and thus description thereof is omitted.

The number-of-fall field stores the number of communication apparatuses T that may possibly have fallen. The number-of-confinement field stores the number of communication apparatuses T that may possibly have been confined. The number-of-submergence field stores the number of communication apparatuses T that may possibly have been submerged. The number-of-fire field stores the number of communication apparatuses T that may possibly have been involved in a fire. The transmitted/untransmitted field stores whether the summary information has been transmitted. The summary information is, for example, the contents of the time field, the position field, and one or more number-of-state fields.

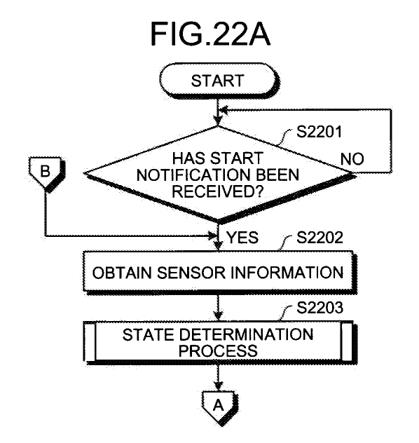

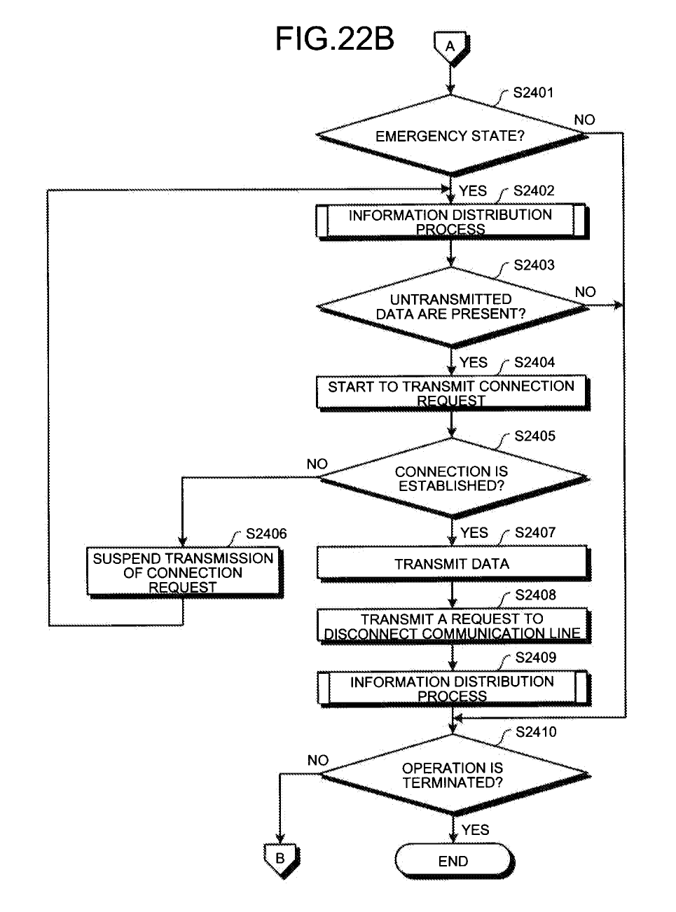

Details of a first example of the congestion suppression process performed by the communication apparatus T applied to the automatic disaster warning apparatus are described next with reference to FIGS. 22 and 23. In the first example, the communication apparatus T suspends the ongoing connection process to the network N if untransmitted data are not present any more in the data stored therein. Thus, the communication apparatus T suspends the transmission of the connection request to the base station BS, thereby reducing the processing load of the base station BS and suppressing the congestion of the network N.

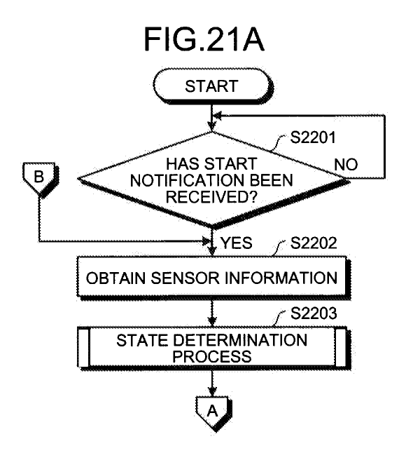

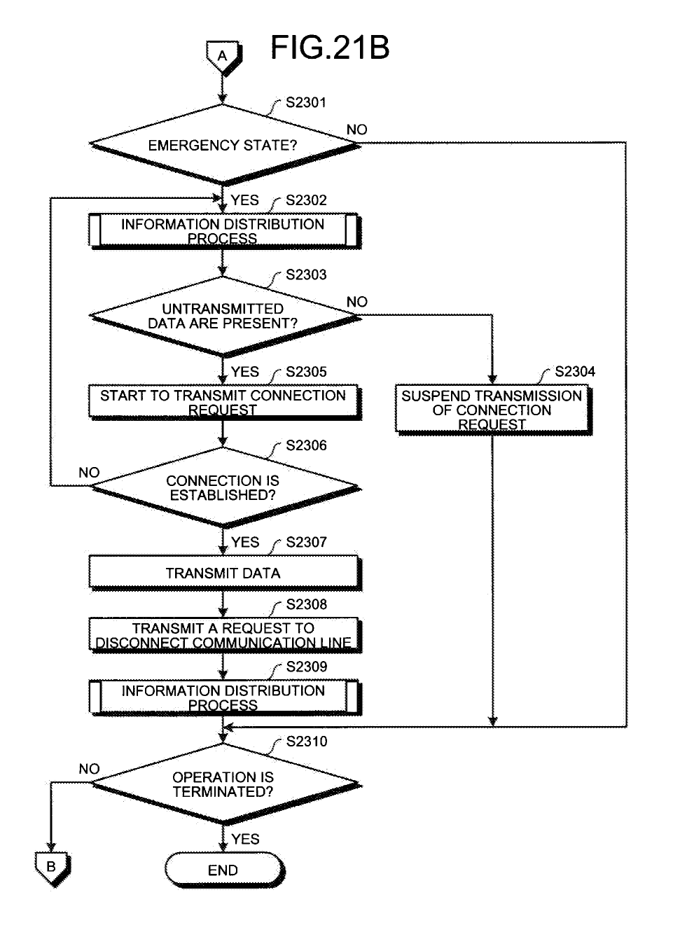

FIGS. 22 and 23 are flowcharts of the first example of the congestion suppression process performed by the communication apparatus T applied to the automatic disaster warning apparatus. As depicted in FIG. 21A, the communication apparatus T determines whether a start notification is received (step S2201). For example, the communication apparatus T determines the start notification is received upon reception of a disaster warning such as the Earthquake Early Warning or an input of a start instruction from a user.

If no start notification is received (step S2201: NO), the communication apparatus T waits for the start notification at step S2201. If a start notification is received (step S2201: YES), the communication apparatus T obtains sensor information from the sensors S1 to Sn (step S2202), executes the state determination process to determine the type of the disaster from which the communication apparatus T is suffering as described in FIG. 19, and transitions to step S2301 of FIG. 21B.

As depicted in FIG. 21B, the communication apparatus T determines whether the communication apparatus T is in an emergency state in which the communication apparatus T is suffering from a disaster and needs to transmit an emergency notification (step S2301). If not (step S2301: NO), the communication apparatus T transitions to step S2310.

If the communication apparatus T is in an emergency state (step S2301: YES), the communication apparatus T executes the information distribution process described with reference to FIG. 17 (step S2302). Thus, the communication apparatus T transmits to the other communication apparatuses T in the communication area, data indicating the state thereof and information indicating whether the data have been transmitted. The communication apparatus T receives from the other communication apparatuses T in the communication area, data indicating the states of the other communication apparatuses T in the communication area and information indicating whether the data have been transmitted.

The communication apparatus T determines whether untransmitted data are present in the data stored therein (step S2303). If not (step S2303: NO), the communication apparatus T suspends the transmission of the connection request to the base station BS (step S2304), and transitions to step S2310.

If untransmitted data are present (step S2303: YES), the communication apparatus T executes the transmission of the connection request to the base station BS (step S1505), and determines whether the connection to the base station BS is established (step S2306). If not (step S2306: NO), the communication apparatus T returns to step S2302.

If the connection is established (step S2306: YES), the communication apparatus T transmits the untransmitted data to the destination via the base station BS (step S2307), transmits a request to disconnect the connected communication line to the base station BS (step S2308), and executes the information distribution process described with reference to FIG. 17 (step S2309).

The communication apparatus T determines whether to terminate operation (step S2310). For example, the communication apparatus T determines to terminate the operation when a cancel notification of the disaster warning is received, or when a given period of time has passed since the reception of the disaster warning, or an instruction to terminate operation is input from a user. If the operation is not terminated (step S2310: NO), the communication apparatus T transitions to step S2202 of FIG. 21A. If the operation is terminated (step S2310: YES), the communication apparatus T terminates the congestion suppression process.

Thus, the communication apparatus T transmits to the other communication apparatuses T, if the untransmitted data are successfully transmitted to the destination, information indicating the untransmitted data have been transmitted. The communication apparatus T determines, if the information indicating the untransmitted data have been transmitted, the data need not to be transmitted therefrom and suspends the transmission of the connection request to the base station BS. Thus, the transmission of the connection request by the communication apparatus T to the base station BS is suspended, thereby reducing the processing load of the base station BS and suppressing the congestion of the network N.

Thus, upon reception of the disaster warning, the communication apparatus T identifies the type of the disaster from which the communication apparatus T is suffering and notifies an emergency automatically, thereby calling a rescue even when the user of the communication apparatus T is unconscious. Further, if the emergency notification includes the state information, the recipient of the emergency notification can grasp the position and the type of the disaster from which the communication apparatus T is suffering, which helps to create a rescue plan. If the emergency notification includes the summary information, the recipient of the emergency notification can grasp where and how many communication apparatuses T are suffering from the disaster and the type of the disaster, which helps to create a rescue plan.

Details of a second example of the congestion suppression process performed by the communication apparatus T applied to the automatic disaster warning apparatus are described next with reference to FIG. 22B. In the second example, the communication apparatus T does not continue and suspends the connection process when the connection to the network N by the connection process has failed. The communication apparatus T does not start the connection process to the network N if untransmitted data are not present any more in the data stored therein. Thus, the communication apparatus T does not transmit the connection request to the base station BS after the untransmitted data are not present any more in the data stored therein, thereby reducing the processing load of the base station BS and suppressing the congestion of the network N.

FIG. 22B is a flowchart of the second example of the congestion suppression process performed by the communication apparatus T to the automatic disaster warning apparatus. Similar to the first example, the processes depicted in FIG. 22A (step S2201 to step S2203) are executed in the second example. The communication apparatus T transitions to S2401 of FIG. 22B after step S2203.

As depicted in FIG. 22B, the communication apparatus T determines whether the communication apparatus T is in an emergency state in which the communication apparatus T is suffering from a disaster and needs to transmit an emergency notification (step S2401). If not (step S2401: NO), the communication apparatus T transitions to step S2410.

If the communication apparatus T is in an emergency state (step S2401: YES), the communication apparatus T executes the information distribution process described with reference to FIG. 17 (step S2402). Thus, the communication apparatus T transmits to the other communication apparatuses T in the communication area, data indicating the state thereof and information indicating whether the data have been transmitted. The communication apparatus T receives from the other communication apparatuses T in the communication area, data indicating the states of the other communication apparatuses T in the communication area and information indicating whether the data have been transmitted.

The communication apparatus T determines whether untransmitted data are present in the data stored therein (step S2403). If not (step S2403: NO), the communication apparatus T transitions to step S2410.

If untransmitted data are present (step S2403: YES), the communication apparatus T executes the transmission of the connection request to the base station BS (step S2404), and determines whether the connection to the base station BS is established (step S2405). If not (step S2405: NO), the communication apparatus T suspends the transmission of the connection request to the base station BS and returns to step S2402.

If the connection is established (step S2405: YES), the communication apparatus T transmits the untransmitted data to the destination via the base station BS (step S2407), transmits a request to disconnect the connected communication line to the base station BS (step S2408), and executes the information distribution process described with reference to FIG. 17 (step S2409).

The communication apparatus T determines whether to terminate operation (step S2410). If not (step S2410: NO), the communication apparatus T transitions to step S2202 of FIG. 21A. If so (step S2410: YES), the communication apparatus T terminates the congestion suppression process.

Thus, the communication apparatus T transmits to the other communication apparatuses T, if the untransmitted data are successfully transmitted to the destination, information indicating the untransmitted data have been transmitted. The communication apparatus T suspends the transmission of the connection request to the base station BS if the connection to the network N has failed. The communication apparatus T determines, if the information indicating the untransmitted data have been transmitted, the data need not to be transmitted therefrom and does not start the transmission of the connection request to the network N. Thus, the transmission of the connection request by the communication apparatus T to the base station BS is suspended, thereby reducing the processing load of the base station BS and suppressing the congestion of the network N.

Thus, upon reception of the disaster warning, the communication apparatus T identifies the type of the disaster from which the communication apparatus T is suffering and notifies an emergency automatically, thereby calling a rescue even when the user of the communication apparatus T is unconscious. Further, if the emergency notification includes the state information, the recipient of the emergency notification can grasp the position and the type of the disaster from which the communication apparatus T is suffering, which helps to create a rescue plan. If the emergency notification includes the summary information, the recipient of the emergency notification can grasp where and how many communication apparatuses T are suffering from the disaster and the type of the disaster, which helps to create a rescue plan.

Details of the state determination process performed by the communication apparatus T applied to the automatic disaster warning apparatus are the same as those depicted in FIG. 16, and thus description thereof is omitted. As described with reference to FIG. 19, the type of the disaster from which the communication apparatus T is suffering is identified at step S1702. Thus, the communication apparatus T identifies the type of the disaster based on the sensor information, and updates the state information table 400 based on the data indicating the identified disaster.

Details of the information distribution process performed by the communication apparatus T applied to the automatic disaster warning apparatus are the same as those depicted in FIG. 17, and thus description thereof is omitted. Thus, the communication apparatus T exchanges the data stored therein and the information indicating whether the data has been transmitted with other communication apparatuses T in the communication area, whereby the communication apparatus T stores therein data indicating the type of the disaster from which the other communication apparatuses T in the communication area are suffering, and information indicating whether the data have been transmitted.

As described above, the communication apparatuses T located in the other's communication area have the same data, and execute the connection process to the network N to transmit the data to the destination. If any of the communication apparatuses T has successfully connected to the network N, the communication apparatus T transmits the data to the destination and transmits to the other communication apparatuses T, information indicating the data have been transmitted. The other communication apparatuses T suspend the transmission of the data therefrom upon reception of the information indicating the data have been transmitted.

Thus, the communication apparatus T suspends the transmission of the connection request to the base station BS performed by the connection process, thereby reducing the processing load of the base station BS and suppressing the congestion of the network N. The communication apparatus T executes the connection process to the network N and transmits the data to the destination in cooperation with the other communication apparatuses T in the communication area, thereby improving the success rate of data transmission.

The communication apparatuses T located in the other's communication area have the same data, execute the connection process intermittently to the network N to transmit the data to the destination, and suspend the connection process if the connection has failed. If any of the communication apparatuses T has successfully connected to the network N, the communication apparatus T transmits the data to the destination and transmits to the other communication apparatuses T, information indicating the data have been transmitted. The other communication apparatuses T do not start the transmission of the data therefrom upon reception of the information indicating the data have been transmitted.

Thus, the communication apparatus T suspends the transmission of the connection request to the base station BS performed by the connection process, thereby reducing the processing load of the base station BS and suppressing the congestion of the network N. The communication apparatus T executes the connection process to the network N and transmits the data to the destination in cooperation with the other communication apparatuses T in the communication area, thereby improving the success rate of data transmission.

Upon reception of the information indicating the data have been transmitted, the communication apparatus T updates the information stored therein and indicating the data have not yet been transmitted so as to indicate the data have been transmitted, and transmits the updated information to the other communication apparatuses T in the communication area. Thus, the communication apparatus T updates the information indicating whether the data stored therein have been transmitted to the latest information. The communication apparatus T also relays and transmits to the other communication apparatuses T, the information indicating the data have been transmitted.

The communication apparatus T executes the connection process to the network N only when the communication apparatus T satisfies the connection requirement. Thus, the communication apparatus T does not execute the connection process when the communication apparatus T does not satisfy the connection requirement, thereby reducing the processing load of the base station BS, suppressing the congestion of the network N, and suppressing the battery consumption.

The communication apparatus T suspends the connection process to the network N when a condition to suspend data transmission is satisfied, thereby reducing the processing load of the base station BS, suppressing the congestion of the network N, and suppressing the battery consumption.

The communication apparatus T executes the congestion suppression process when being instructed by the communication service provider. Thus, the communication service provider can restrict communication only for specific communication apparatuses T (for example, communication apparatuses T located in an area with large traffic), without uniformly restricting communication at the level of the network N. Thus, the communication apparatuses T other than those instructed to execute the congestion suppression process by the communication service provider are not involved in the communication restriction, and can communicate with each other.

The communication method according to the present embodiment may be implemented by executing a preliminarily prepared program, the program being executed by a computer such as a personal computer and a workstation. The communication program is recorded on a computer-readable recording medium such as a hard disk, a flexible disk, a CD-ROM, an MO, and a DVD and is read from the recording medium by the computer for execution. The communication program may be distributed through a network such as the Internet.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A communication apparatus comprising:
a first communication unit that communicates with one or more other communication apparatus(es) located in a communication area of the communication apparatus;
a second communication unit that communicates with any of base stations in a mobile communication network; and
a processor configured to:
cause the first communication unit to receive from the other communication apparatus(es), information indicating whether identical data stored in the communication apparatus and the other communication apparatus(es) have been transmitted to a destination in the mobile communication network;
determine whether the data have been transmitted based on the information received by the first communication unit and information stored in the communication apparatus and indicating whether the data have been transmitted;
cause, upon determining that the data have not yet been transmitted, the second communication unit to execute a connection process to the mobile communication network via the base station and to transmit the data to the destination via the base station;
update, if the second communication unit successfully transmits the data, the information stored in the communication apparatus so as to indicate that the data have been transmitted;
cause, upon updating the information, the first communication unit to distribute the updated information to the other communication apparatus(es); and
cause, upon determining that the data have been transmitted, the second communication unit to suspend the ongoing connection process.

2. The communication apparatus according to claim 1, wherein the processor updates the information stored in the communication apparatus so as to indicate the data have been transmitted, if the information received by the first communication unit indicates that the data have been transmitted, the information stored in the communication apparatus indicates that the data have not yet been transmitted, and the processor determines the data have been transmitted.

3. The communication apparatus according to claim 1, wherein
the processor determines whether the communication apparatus satisfies a connection requirement to the mobile communication network, and
the processor causes, upon determining that the data have not yet been transmitted and that the communication apparatus satisfies the connection requirement, the second communication unit to execute the connection process to the mobile communication network via the base station and to transmit the data to the destination via the base station.

4. The communication apparatus according to claim 1, the processor further configured to decide whether to suspend the transmission of the data from the communication apparatus, wherein
the processor causes, upon deciding to suspend the transmission, the second communication unit to suspend the ongoing connection process.

5. A communication apparatus comprising:
a first communication unit that communicates with one or more other communication apparatus(es) located in a communication area of the communication apparatus;
a second communication unit that communicates with any of base stations in a mobile communication network; and
a processor configured to:
cause the first communication unit to receive from the other communication apparatus(es), information indicating whether identical data stored in the communication apparatus and the other communication apparatus(es) have been transmitted to a destination in the mobile communication network;
determine whether the data have been transmitted based on the information received by the first communication unit and information stored in the communication apparatus and indicating whether the data have been transmitted;
cause, upon determining that the data have not yet been transmitted, the second communication unit to execute a connection process to the mobile communication network via the base station and to transmit the data to the destination via the base station;
update, if the second communication unit successfully transmits the data, the information stored in the communication apparatus so as to indicate that the data have been transmitted;
cause, upon updating the information, the first communication unit to distribute the updated information to the other communication apparatus(es); and
cause, if the connection process fails to establish a connection, the second communication unit to suspend the ongoing connection process.

6. The communication apparatus according to claim 5, wherein the processor updates, if the information received by the first communication unit indicates that the data have been transmitted, the information stored in the communication apparatus indicates that the data have not yet been transmitted, and the processor determines that the data have been transmitted, the information stored in the communication apparatus so as to indicate that the data have been transmitted.

7. The communication apparatus according to claim 5, wherein
the processor determines whether the communication apparatus satisfies a connection requirement to the mobile communication network, and
the processor causes, upon determining that the data have not yet been transmitted and if the communication apparatus satisfies the connection requirement, the second communication unit to execute the connection process to the mobile communication network via the base station and to transmit the data to the destination via the base station.

8. The communication apparatus according to claim 5, the processor further configured to decide whether to suspend the transmission of the data from the communication apparatus, wherein
the processor causes, upon deciding to suspend the transmission, the second communication unit to suspend the ongoing connection process.

9. A communication method executed by a computer, the communication method comprising:
causing a first communication unit that communicates with one or more other communication apparatus(es) located in a communication area of the communication apparatus to receive from the other communication apparatus(es), information indicating whether identical data stored in the communication apparatus and the other communication apparatus(es) have been transmitted to a destination in a mobile communication network;
determining whether the data have been transmitted based on the information received by the first communication unit and information stored in the communication apparatus and indicating whether the data have been transmitted;
causing, upon determining that the data have not been transmitted, a second communication unit that communicates with any of base stations in the mobile communication network to execute a connection process to the mobile communication network via the base station and to transmit the data to the destination via the base station;
updating, if the second communication unit successfully transmits the data, the information stored in the communication apparatus so as to indicate that the data have been transmitted;
causing, upon updating the information, the first communication unit to distribute the updated information to the other communication apparatus(es); and
causing, upon determining that the data have been transmitted, the second communication unit to suspend the ongoing connection process.

10. A communication method executed by a computer, the communication method comprising:
causing a first communication unit that communicates with one or more other communication apparatus(es) located in a communication area of the communication apparatus to receive from the other communication apparatus(es), information indicating whether identical data stored in the communication apparatus and the other communication apparatus(es) have been transmitted to a destination in a mobile communication network;
determining whether the data have been transmitted based on the information received by the first communication unit and information stored in the communication apparatus and indicating whether the data have been transmitted;
causing, upon determining that the data have not been transmitted, a second communication unit that communicates with any of base stations in the mobile communication network to execute a connection process to the mobile communication network via the base station and to transmit the data to the destination via the base station;
updating, if the second communication unit successfully transmits the data, the information stored in the communication apparatus so as to indicate that the data have been transmitted;
causing, upon updating the information, the first communication unit to distribute the updated information to the other communication apparatus(es); and
causing, if the connection process fails to establish a connection, the second communication unit to suspend the ongoing connection process.

11. A computer-readable recording medium storing a communication program causing a computer to execute a process comprising:
causing a first communication unit that communicates with one or more other communication apparatus(es) located in a communication area of the communication apparatus to receive from the other communication apparatus(es), information indicating whether identical data stored in the communication apparatus and the other communication apparatus(es) have been transmitted to a destination in a mobile communication network;
determining whether the data have been transmitted based on the information received by the first communication unit and information stored in the communication apparatus and indicating whether the data have been transmitted;
causing, upon determining that the data have not been transmitted, a second communication unit that communicates with any of base stations in the mobile communication network to execute a connection process to the mobile communication network via the base station and to transmit the data to the destination via the base station;
updating, if the second communication unit successfully transmits the data, the information stored in the communication apparatus so as to indicate the data have been transmitted;
causing, upon updating the information, the first communication unit to distribute the updated information to the other communication apparatus(es); and
causing, upon determining that the data have been transmitted, the second communication unit to suspend the ongoing connection process.

12. A computer-readable recording medium storing a communication program causing a computer to execute a process comprising:
causing a first communication unit that communicates with one or more other communication apparatus(es) located in a communication area of the communication apparatus to receive from the other communication apparatus(es), information indicating whether identical data stored in the communication apparatus and the other communication apparatus(es) have been transmitted to a destination in a mobile communication network;
determining whether the data have been transmitted based on the information received by the first communication unit and information stored in the communication apparatus and indicating whether the data have been transmitted;
causing, upon determining that the data have not been transmitted, a second communication unit that communicates with any of base stations in the mobile communication network to execute a connection process to the mobile communication network via the base station and to transmit the data to the destination via the base station;
updating, if the second communication unit successfully transmits the data, the information stored in the communication apparatus so as to indicate the data have been transmitted;
causing, upon updating the information, the first communication unit to distribute the updated information to the other communication apparatus(es); and
causing, if the connection process fails to establish a connection, the second communication unit to suspend the ongoing connection process.
